(19) United States
(12) Patent Application Publication
(10) Pub. No.: US 2022/0383024 A1
(43) Pub. Date: Dec. 1, 2022

(54) METHOD, APPARATUS, AND SYSTEM FOR DETECTING AND CODING A ROAD STACK INTERCHANGE BASED ON IMAGE DATA

(71) Applicant: HERE Global B.V., Eindhoven (NL)

(72) Inventors: Ashish Deepchand YADAV, Mumbai (IN); Jigar Vasant WAGHELA, Mumbai (IN)

(21) Appl. No.: 17/332,530

(22) Filed: May 27, 2021

(51) Int. Cl. G06K 9/00; G06K 9/50

(52) U.S. Cl. CPC G06K 9/00651; G06K 9/50

(57) ABSTRACT

An approach is provided for detecting and coding a grade-separated road intersection based on image data. The approach involves, for example, retrieving an image depicting a road intersection from a top-down perspective. The road intersection comprises two or more road links. The approach also involves processing the image to determine continuity data of the two or more road links. The continuity data represents a visual continuity of respective depictions of the two or more road links in the image. The approach further involves determining a stacking order of the two or more road links based on the continuity data. The approach further involves providing the stacking order as an output.

### BACKGROUND

Location-based service providers (e.g., mapping and navigation providers) are continually challenged to provide compelling services and applications. One area of development relates to providing users navigation support when traveling on a road network. Providing accurate map data is a key aspect of providing such support. Road stack level coding of a grade-separated road intersection (e.g., an overpass, underpass, bridge, stack interchange, etc.) indicates its location, features and/or characteristics (e.g., a stacking order, width, height, length, etc.) that can significantly affect traffic flows; hence need to be accurately coded in maps (e.g., digital maps). However, accurate road stack feature data is often difficult and/or expensive to obtain (e.g., due to manual input requirements, computation resource requirements, etc.). Accordingly, mapping service providers face significant technical challenges to efficiently and accurately detect and code a grade-separated road intersection and its attributes.

### Some Example Embodiments

Therefore, there is a need for an approach for efficiently and accurately detecting and coding a grade-separated road intersection based on image data.

According to one embodiment, a method comprises retrieving an image depicting a road intersection from a top-down perspective. The road intersection comprises two or more road links. The method also comprises processing the image to determine continuity data of the two or more road links. The continuity data represents a visual continuity of respective depictions of the two or more road links in the image. The method further comprises determining a stacking order of the two or more road links based on the continuity data. The method further comprises providing the stacking order as an output.

According to another embodiment, an apparatus comprising at least one processor, and at least one memory including computer program code, the at least one memory and the computer program code configured to, with the at least one processor, cause the apparatus to retrieve an image depicting a road intersection from a top-down perspective. The road intersection comprises two or more road links. The apparatus is also caused to process the image to determine continuity data of the two or more road links. The continuity data represents a visual continuity of respective depictions of the two or more road links in the image. The apparatus is further caused to determine a stacking order of the two or more road links based on the continuity data. The apparatus is further caused to provide the stacking order as an output.

According to another embodiment, a computer-readable storage medium carrying one or more sequences of one or more instructions which, when executed by one or more processors, cause an apparatus to retrieve an image depicting a road intersection from a top-down perspective. The road intersection comprises two or more road links. The apparatus is also caused to process the image to determine continuity data of the two or more road links. The continuity data represents a visual continuity of respective depictions of the two or more road links in the image. The apparatus is further caused to determine a stacking order of the two or more road links based on the continuity data. The apparatus is further caused to provide the stacking order as an output.

According to another embodiment, an apparatus comprises means for retrieving an image depicting a road intersection from a top-down perspective. The road intersection comprises two or more road links. The apparatus also comprises means for processing the image to determine continuity data of the two or more road links. The continuity data represents a visual continuity of respective depictions of the two or more road links in the image. The apparatus further comprises means for determining a stacking order of the two or more road links based on the continuity data. The apparatus further comprises means for providing the stacking order as an output.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system for detecting and coding a grade-separated road intersection based on image data, according to one embodiment;

FIG. 2A are diagrams of example top-down images of a multi-stack interchange, according to one embodiment;

FIG. 2B is a diagram illustrating an example process for detecting and coding a grade-separated road intersection based on top-down image data, according to one embodiment;

FIG. 2C are diagrams of example road links with stack level value assignment, according to various embodiments;

FIG. 3 is a diagram of the components of a mapping platform, according to one embodiment;

FIG. 4 is a flowchart of a process for detecting and coding a grade-separated road intersection based on image data, according to one embodiment;

FIG. 5 are diagrams of example top-down images of a two-stack interchange, according to one embodiment;

FIG. 6 are diagrams of example top-down images of a road link/waterway junction, according to one embodiment;

FIG. 7A are diagrams of example street-level imagery of a two-stack interchange, according to one embodiment;

FIG. 7B is a diagram illustrating an example process for detecting and coding a grade-separated road intersection based on street-level imagery, according to one embodiment;

FIG. 8 is a diagram illustrating a tagging table, according to one embodiment;

FIG. 9 is a diagram of an example table of junction categories, according to various embodiments;

FIG. 10 are diagrams of example drive images of a multi-stack junction structure, according to one embodiment;

FIG. 11A are diagrams of an elevation approach, according to one embodiment;

FIG. 11B is a diagram illustrating the example process for detecting and coding a grade-separated road intersection based on elevation data, according to one embodiment;

FIG. 11C are diagrams of example cases for calculating an junction elevation difference of road links, according to various embodiments;

FIG. 12 is a diagram of example hybrid approaches for determining a stacking order at a junction, according to various embodiments;

FIGS. 13A and 13B are diagrams of example user interfaces for routing via a congested grade-separated road intersection, according to various embodiments;

FIG. 14 is a diagram of a geographic database, according to one embodiment;

FIG. 15 is a diagram of hardware that can be used to implement an embodiment;

FIG. 16 is a diagram of a chip set that can be used to implement an embodiment; and

FIG. 17 is a diagram of a mobile terminal (e.g., handset or vehicle or part thereof) that can be used to implement an embodiment.

### DESCRIPTION OF SOME EMBODIMENTS

Examples of a method, apparatus, and computer program for detecting and coding a grade-separated road intersection based on image data are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

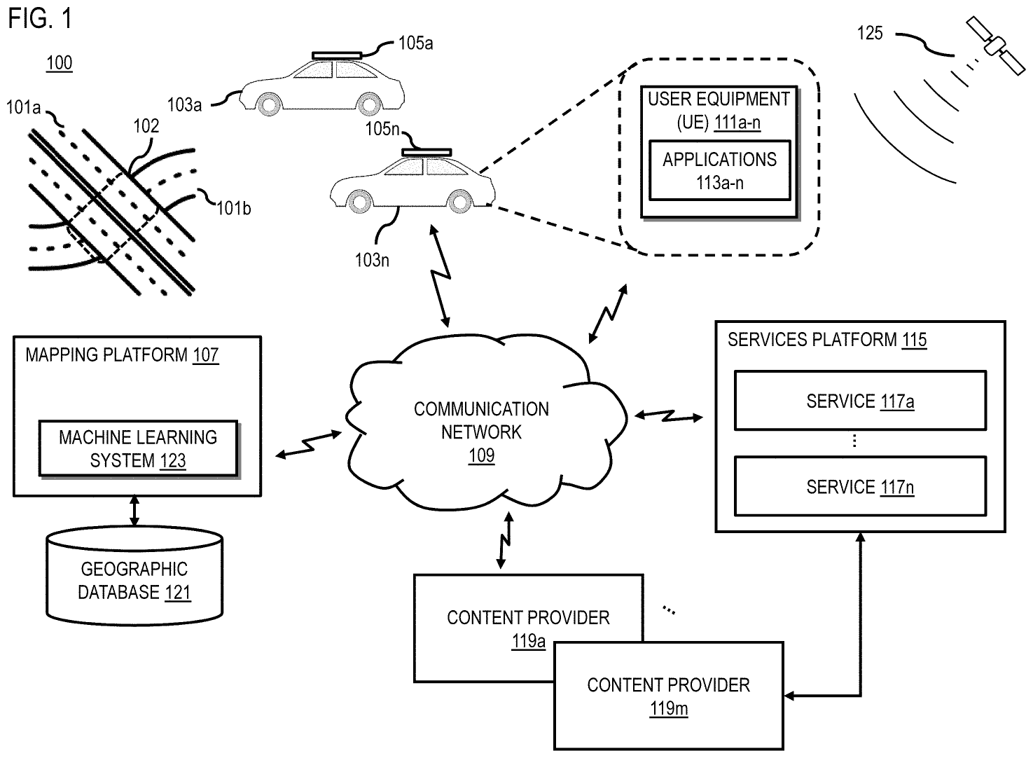

FIG. 1 is a diagram of a system for detecting and coding a grade-separated road intersection based on image data, according to one embodiment. A grade-separated road intersection is a transport junction where traffic can change between different routes, directions, and/or modes of transport (e.g., roads, footpaths, railways, canals, waterways, airport runways, etc.). An overpass can be a road (including ramp, bridge, etc.) passing over another road at a ground level, and a underpass: can be a road (e.g., a tunnel) passing through a structure or object having another road structure over it at a certain vertical height. A stack interchange is one example of a grade-separated road junction typically with one or more ramps. To achieve desired grade separation, overpasses (e.g., bridges) and/or underpasses (e.g., tunnels) can be built at a stack interchange.

As described above, location-based service providers (e.g., mapping and navigation providers) are continually challenged to provide compelling services and applications. One area of development relates to providing users navigation support when traveling on a road or a road network. Providing accurate map data is a key aspect of providing such support. Grade-separated road intersections (e.g., overpasses, underpasses, stack interchanges, etc.) are map features and their characteristics (e.g., stacking orders, vertical distances, widths, heights, lengths, etc.) can significantly affect traffic flows; hence they need to be accurately coded in maps (e.g., digital maps). For example, a stack interchange has turning ramps stacked in various configurations above or below the interchanging roadways, that allow vehicles to move cross the roadways and merge to the traffic of a different direction. Stacks eliminate the problems of weaving and increase traffic capacities.

However, obtaining accurate interchange feature data is often difficult and/or expensive (e.g., due to manual input requirements, computation resource requirements, etc.). For instance, it can be difficult to detect an interchange stacking order and/or other features simply using probe data. Some mapping processes can identify a location of a stack level point where two or more road links cross each other or one another in a form of an overpass, underpass, or interchange, detect a road stack level using video drive files (e.g., captured by vehicle camera), and then code the overpass/underpass/interchange manually. However, the manual processes can be time consuming and susceptible to human errors. Accordingly, mapping service providers face significant technical challenges to efficiently and accurately detect and code interchanges or the like and their attributes.

To address these problems, the system 100 of FIG. 1 introduces a capability to detect and map-code a grade-separated road intersection in a road network based on probes and image data. In one embodiment, the system 100 can retrieve road intersection data where two or more road links 101 (e.g., road links 101a, 101b) intersecting at a grade-separated road intersection 102. This helps the system 100 to tag the presence of the grade-separated road intersection 102 in a map (e.g., a digital map). The system 100 can then determine features/characteristics of the grade-separated road intersection 102 based on top-down image data of the road intersection 102 (i.e., a top-down image approach). For instance, aerial sources (e.g., satellites, airplanes, drones, and/or other aerial vehicles) can capture images from a top-down perspective.

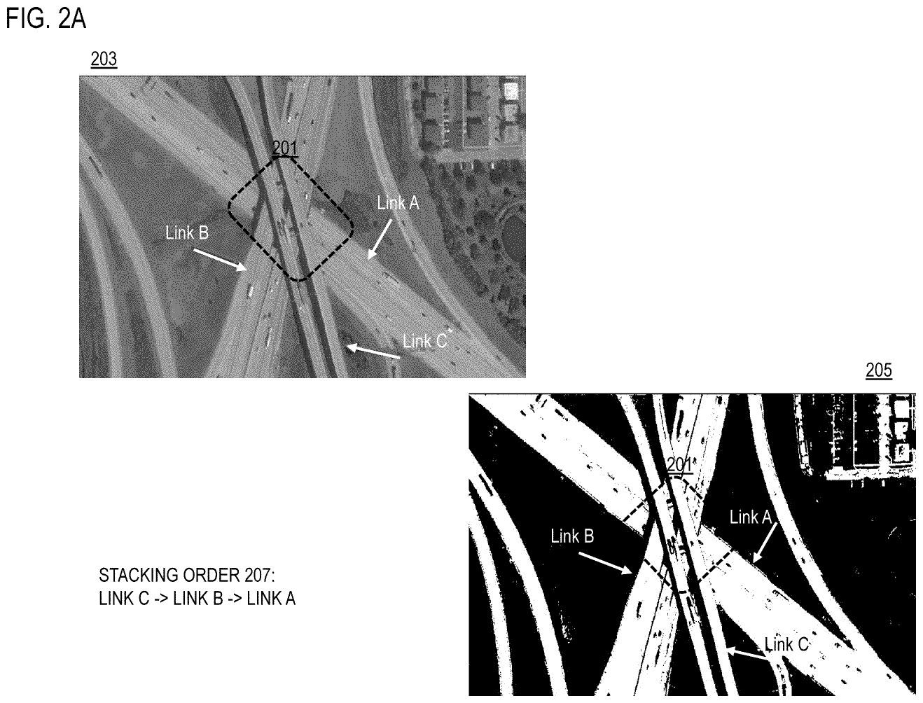

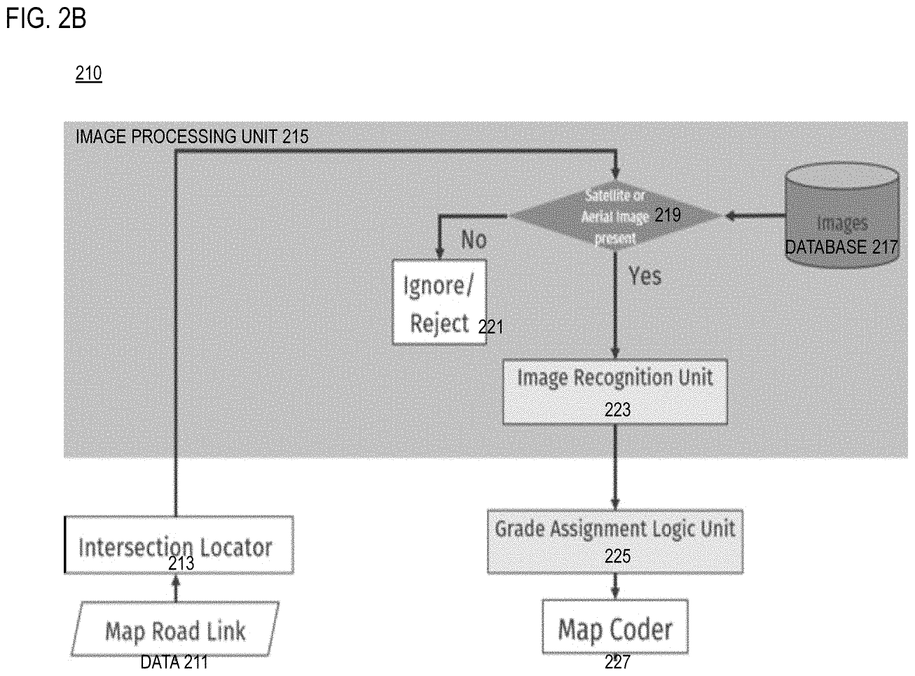

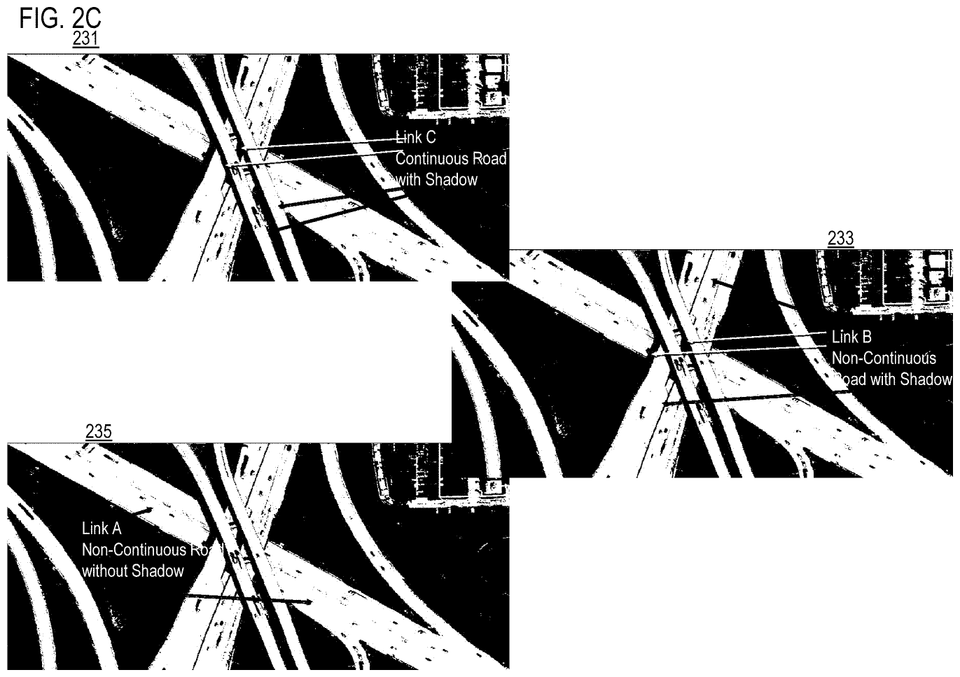

FIG. 2A are diagrams of example top-down images of a multi-stack interchange 201, according to one embodiment. The stack interchange 201 has Link A, Link B, and Link C intersect thereat. For instance, by converting the converting a top-down image 203 (e.g., in color or a gray-scale) into a monochrome image 205, the system 100 can simplify the top-down image 203 and better identify characteristics of the stack interchange 201, such as a stacking order 207: Link C over Link B over Link A, using continuity, shadows, etc. of the road links depicted in the monochrome image 205. The road links are continuous in the real world but can be viewed in the images 203, 205 as non-continuous due to overlapping in the images 203, 205.

FIG. 2B is a diagram illustrating an example process 210 for detecting and coding a grade-separated road intersection based on top-down image data, according to one embodiment. For instance, the system 100 can retrieve map road link data 211 for an intersection locator 213 to determine road link intersection data, and send road link intersection data to an image processing unit 215.

The intersection locator 213 can then process probe data using computer software to tag a location where two or more road links 101 (e.g., road links 101a, 101b) intersecting at a grade-separated road intersection 102. In another embodiment, the intersection locator 213 can determine an interrupt of probe signals (on the road link 101b as blocked by the road link 101a) at the grade-separated road intersection 102. In yet another embodiment, the intersection locator 213 can determine a location of the grade-separated road intersection 102 based on elevation data embedded in the probe data and/or location sensor data collected by vehicles 103 using sensors 105.

A probe point can include attributes such as: (1) source ID, (2) longitude, (3) latitude, (4) elevation, (5) heading, (6) speed, (7) time, and (8) access type. A source/probe can be a vehicle, a drone, a user device travelling with the vehicle, etc. Each of the probe points where probe data is captured is associated with the same probe/source identifier. As such, any probe data captured in connection with the same probe identifier is associated with the same segment of roadway/link, grade-separated road intersection, geographic location, time interval, vehicle/driver, etc. Probe data can be used to define probe (e.g., a vehicle) travel paths, count numbers of contributing vehicles, form “drives” by a location point (together with time information), etc. This property of probe data transmission can result in discontinuity and lack of probe data from vehicles 103 in the potential grade-separated road intersection. When analyzing the probe data of multiple hours/days/weeks/months/etc., the intersection locator 213 can identify a break/gap in probe data on a streamline probe signal at a road junction or in a road network, which is a significant indication of the presence of a grade-separated road intersection 102 with an upper road link that can restrict the sensor and/or communication signal transmission between vehicle probes on the lower road link and a satellite/communication tower.

Referring back to FIG. 2B, the image processing unit 215 can determine the existence of a top-down Image at the location of the road intersection 102 in an images database 217 in a step 219, such as whether there is at least one satellite or aerial image (e.g., the image 203 in FIG. 2A) depicting the location of the road intersection 102. When determining such image is missing from the images database 217, the image processing unit 215 can discard or reject the road link intersection in Step 221. When determining such image is available in the images database 217, the image processing unit 215 can process and convert such top-down image (e.g., a satellite or aerial image, the image 203 in FIG. 2A, etc.) into a monochrome image (e.g., the image 205 in FIG. 2A) and send the monochrome image to an image recognition unit 223.

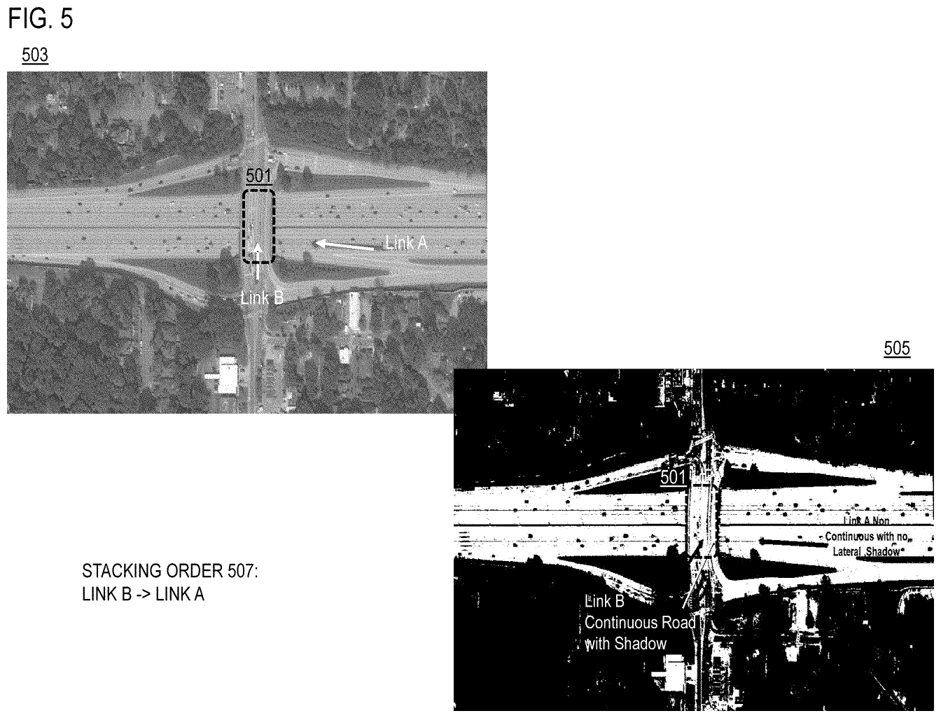

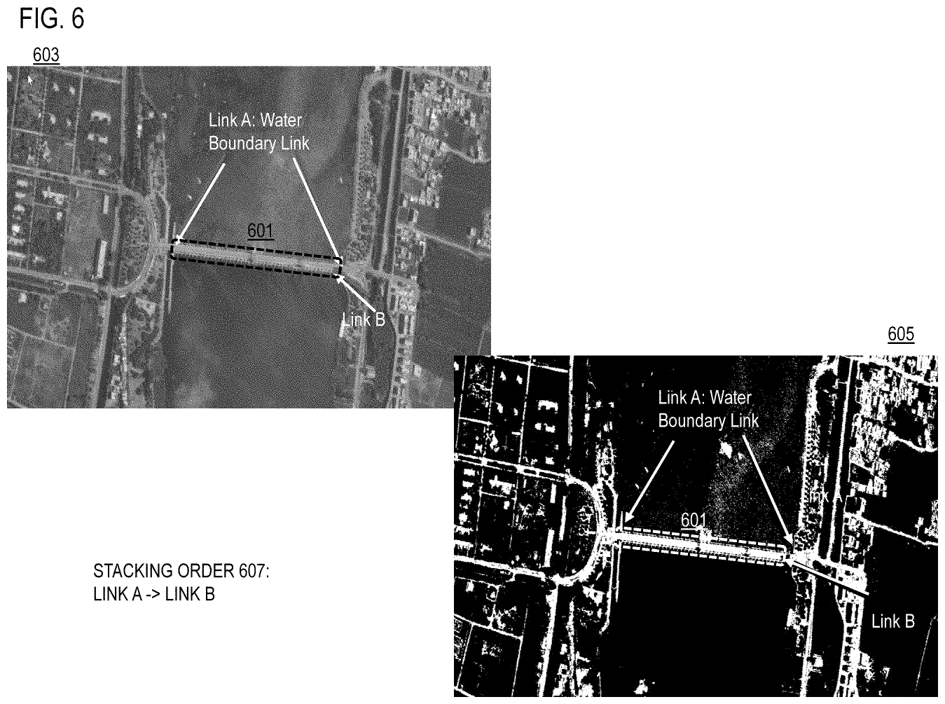

In one embodiment, the image recognition unit 223 can differentiate the road links (e.g., Link A, Link B, and Link C in FIG. 2A) in the monochrome image based on different criteria and scenarios, and send the data to a stack/grade level assignment unit 225. The scenarios may include: multi-stack level coding (e.g., FIG. 2A), two-stack level coding (e.g., FIG. 5), road link and water feature (or subway path) stack level coding (e.g., FIG. 6), etc.

The stack/grade level assignment unit 225 can assign a stack level value to a link participating/intersecting at the grade-separated road intersection 102 based on the pre-defined criteria and logic. For instance, the criteria for multi-stack level coding can be: (1) A road structure or link which show continuity in the monochrome image, regardless with or without lateral shadow should be assigned with a stack level value of 2. (2) Excluding the road structure or Link which is already being identified and a stack Level is assigned in (1), the other road link having lateral shadow and non-continuous in the monochrome image can be assigned with a stack level value of 1. (3) The last remaining road structure or link which is non-continuous and has no lateral shadow can be assigned with a stack level value of zero.

FIG. 2C are diagrams of example road links with stack level value assignment, according to various embodiments. By way of example, Link C showing continuity in a monochrome image 231 of FIG. 2C can be assigned with stack level value of 2. As another example, Link B having lateral shadow and non-continuous in a monochrome image 233 of FIG. 2C can be assigned with a stack level value of 1. As yet another example, Link A shown as non-continuous and without lateral shadow in a monochrome image 235 of FIG. 2C can be assigned with a stack level value of zero.

Once a valid stack level value assigned for a participating road link at the road intersection 102, the stack/grade level assignment unit 225 can send the stack level value data to a map coder 227 and/or a mapping platform 107 connected via a communication network 109 to perform necessary coding of the stack level assignment. The stack level assignment can be done at a road link level or at a point location basis, e.g., a location point where all participating links intersect.

In one embodiment, the system 100 can also collect probe data from one or more user equipment (UE) 111a-111n (also collectively referred to herein as UEs 111) associated with the vehicles 103 (e.g., an embedded navigation system), a user or a passenger of a vehicle 103 (e.g., a mobile device, a smartphone, etc.), or a combination thereof. In one instance, the UEs 111 may include one or more applications 113a-113n (also collectively referred to herein as applications 113) (e.g., a navigation or mapping application). In one embodiment, the system 100 may also collect the probe data from one or more other sources such as government/municipality agencies, local or community agencies (e.g., police departments), and/or third-party official/semi-official sources (e.g., the services platform 115, one or more services 117a-117n, one or more content providers 119a-119m, etc.). In one instance, the probe data collected by the vehicle sensors 105, the UEs 111, one or more other sources, or a combination thereof may be stored in a geographic database 121.

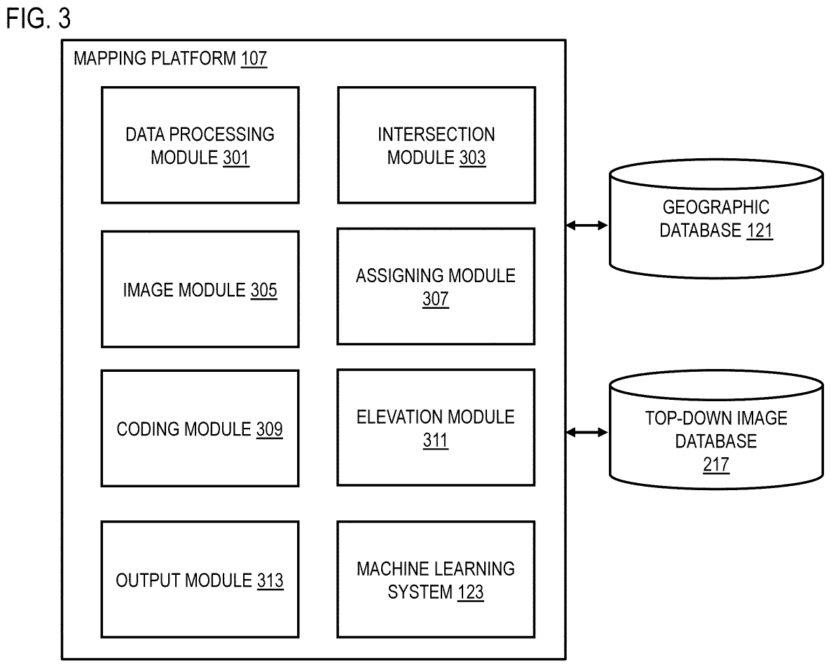

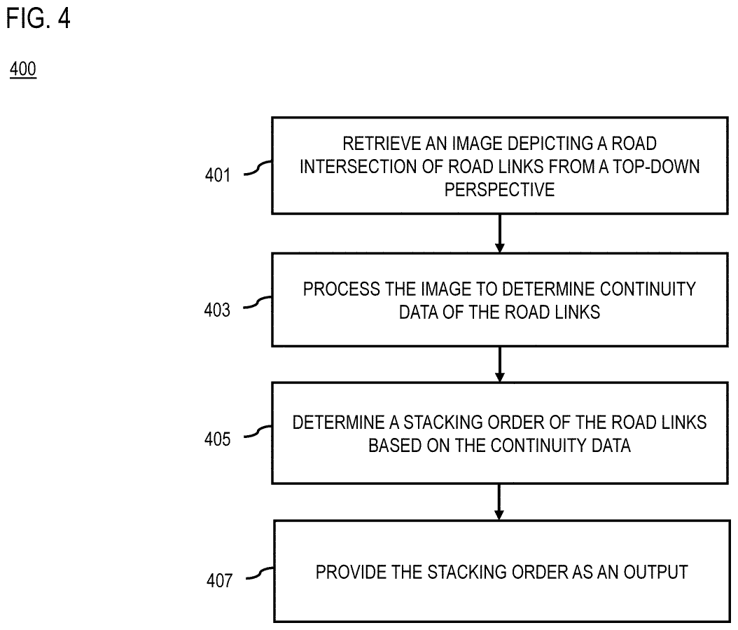

FIG. 3 is a diagram of the components of the mapping platform 107 configured to detect and map-code a grade-separated road intersection based on probes and image data, according to one embodiment. By way of example, the mapping platform 107 includes one or more components for detecting and coding a grade-separated road intersection based on image data, according to the various embodiments described herein. It is contemplated that the functions of these components may be combined or performed by other components of equivalent functionality. In one embodiment, the mapping platform 107 includes an data processing module 301, an intersection module 303, an image module 305, assigning module 307, a coding module 309, an elevation module 311, an output module 313, and a machine learning system 123, and has connectivity to a geographic database 121, and the image database 217. The above presented modules and components of the mapping platform 107 can be implemented in hardware, firmware, software, or a combination thereof. Though depicted as a separate entity in FIG. 1, it is contemplated that the mapping platform 107 may be implemented as a module of any other component of the system 100. In another embodiment, the mapping platform 107 and/or the modules 301-313 may be implemented as a cloud-based service, local service, native application, or combination thereof. The functions of the mapping platform 107, the machine learning system 123, and/or the modules 301-313 are discussed with respect to FIGS. 4-13.

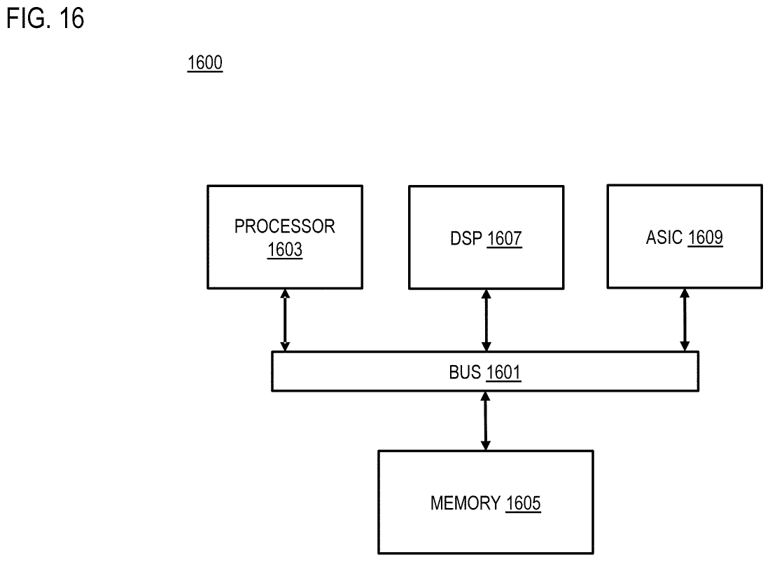

FIG. 4 is a flowchart of a process for detecting and coding a grade-separated road intersection based on image data, according to one embodiment. In various embodiments, the mapping platform 107, the machine learning system 123, and/or any of the modules 301-313 may perform one or more portions of the process 400 and may be implemented in, for instance, a chip set including a processor and a memory as shown in FIG. 16. As such, the mapping platform 107, the machine learning system 123, and/or the modules 301-313 can provide means for accomplishing various parts of the process 400, as well as means for accomplishing embodiments of other processes described herein in conjunction with other components of the system 100. Although the process 400 is illustrated and described as a sequence of steps, its contemplated that various embodiments of the process 400 may be performed in any order or combination and need not include all the illustrated steps.

In one embodiment, the data processing module 301 can aggregate probe data gathered and/or generated by probes resulting from the driving of multiple different vehicles through a given grade-separated road intersection.

In one embodiment, for example, in step 401, the intersection module 303 can retrieve an image depicting a road intersection from a top-down perspective, while the road intersection comprises two or more road links. By way of example, the image is a satellite image or an aerial image.

In one embodiment, in step 403, the image module 305 can process the image to determine continuity data of the two or more road links. The continuity data can represent a visual continuity of respective depictions of the two or more road links in the image. In another embodiment, the processing of the image can comprise converting the image to a monochrome image, and the continuity data can be determined from the monochrome image.

In one embodiment, in step 405, the assigning module 307 can determine a stacking order of the two or more road links based on the continuity data. For instance, the assigning module 307 can assign a top stack level of the stacking order to a road link of the two or more road links based on determining that the continuity data indicates that the respective depictions of the road link in the image is visually continuous.

As another instance, the assigning module 307 can assign a middle stack level of the stacking order to at least one road link of the two or more road links based on determining that (1) the continuity data indicates that the respective depictions of the at least one road link is non-continuous, and (2) respective shadows of the at least one road link are present in the image.

As yet another instance, the assigning module 307 can assign a lowest stack level of the stacking order to a road link of the two or more road links based on determining that (1) the continuity data indicates that the respective depictions of the road link is non-continuous, and (2) a shadow of the road link is not present in the image.

In another embodiment, the system 100 can apply the process of FIG. 2B to a two-stack interchange. FIG. 5 are diagrams of example top-down images of a two-stack interchange 501, according to one embodiment. The two-stack interchange 501 has Link A and Link B intersect thereat. For instance, by converting the converting a top-down image 503 (e.g., in color or a gray-scale) into a monochrome image 505, the system 100 can simplify the top-down image 503 and better identify characteristics of the two-stack interchange 501, such as a stacking order 507: Link B over Link A, using continuity, shadows, etc. of the road links depicted in the monochrome image 505. The road links are continuous in the real world but can be viewed in the images 503, 505 as non-continuous due to overlapping in the images 503, 505.

For instance, the stack/grade level assignment unit 225 of the system 100 can assign a stack level value to a link participating/intersecting at the two-stack interchange 501 based on the pre-defined two-stack level coding criteria and logic: (1) A road structure or link which show continuity in the monochrome image, regardless with or without lateral shadow should be assigned with a stack level value of 1. (2) A road structure or link which is non-continuous and has no lateral shadow can be assigned with a stack level value of zero. The two-stack level coding does not involve any water feature link and polygon.

In another embodiment, the system 100 can apply the process of FIG. 2B to a road link overlapping with a waterway or a subway path. For instance, the assigning module 307 can assign a negative stack level of the stacking order to a road link of the two or more road links based on determining that the road link (e.g., a subway path) is not visible in the image.

As another instance, the assigning module 307 can assign a negative stack level of the stacking order to a road link of the two or more road links based on determining that the road link is associated with a water feature (e.g., a waterway). FIG. 6 are diagrams of example top-down images of a road link/waterway junction 601, according to one embodiment. The road link/waterway junction 601 has a road link (e.g., Link B) passing over a waterway (e.g., Link A). For instance, by converting the converting a top-down image 603 (e.g., in color or a gray-scale) into a monochrome image 605, the system 100 can simplify the top-down image 603 and better identify characteristics of the road link/waterway junction 601, such as a stacking order 607: Link B over Link A, using continuity, shadows, etc. of the road links depicted in the monochrome image 605. The road links are continuous in the real world but can be viewed in the images 603, 605 as non-continuous due to overlapping in the images 603, 605.

For instance, the stack/grade level assignment unit 225 of the system 100 can assign a stack level value to a link participating/intersecting at the road link/waterway junction 601 based on the pre-defined road link and water feature/subway path coding criteria and logic: (1) A road structure or link which show continuity in the monochrome image should be assigned with a stack level value of zero. (2) A link representing a nonexistence of a road network or a water feature should be assigned a stack level value of −1.

In another approach (i.e., a street-level imagery approach), the data processing module 301 can check for existence of street-level imagery (e.g., a vehicle drive files) depicting the grade-separated road intersection 102 in a database. For instance, ground level sources (e.g., vehicles 103 with mounted cameras traveling along surface streets, infrastructure cameras, etc.) which capture street-level images (e.g., in drive files) from a street-level perspective.

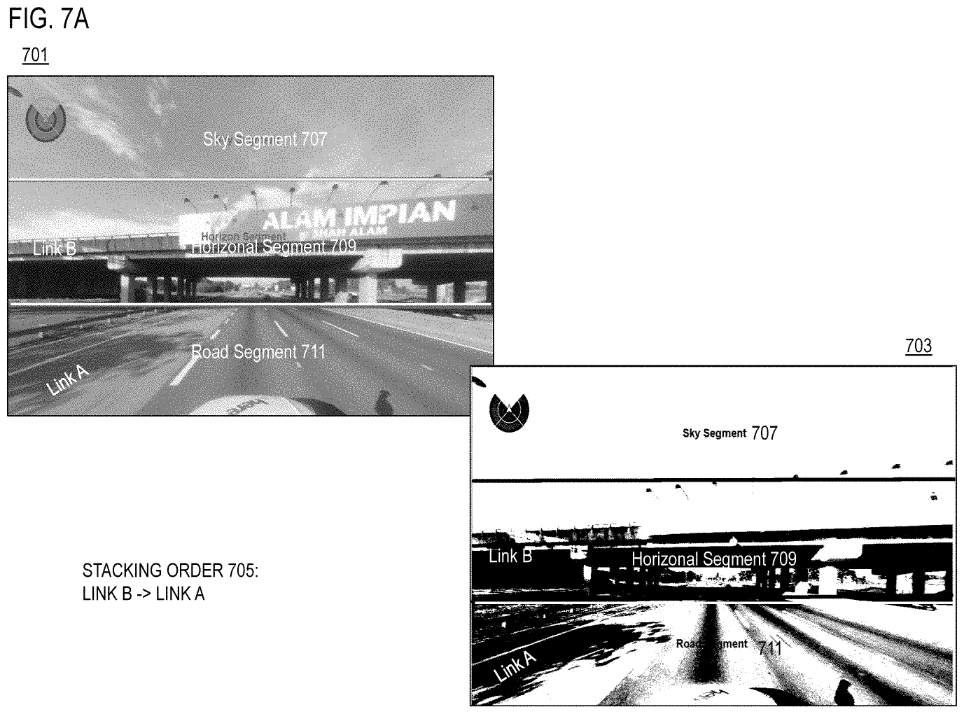

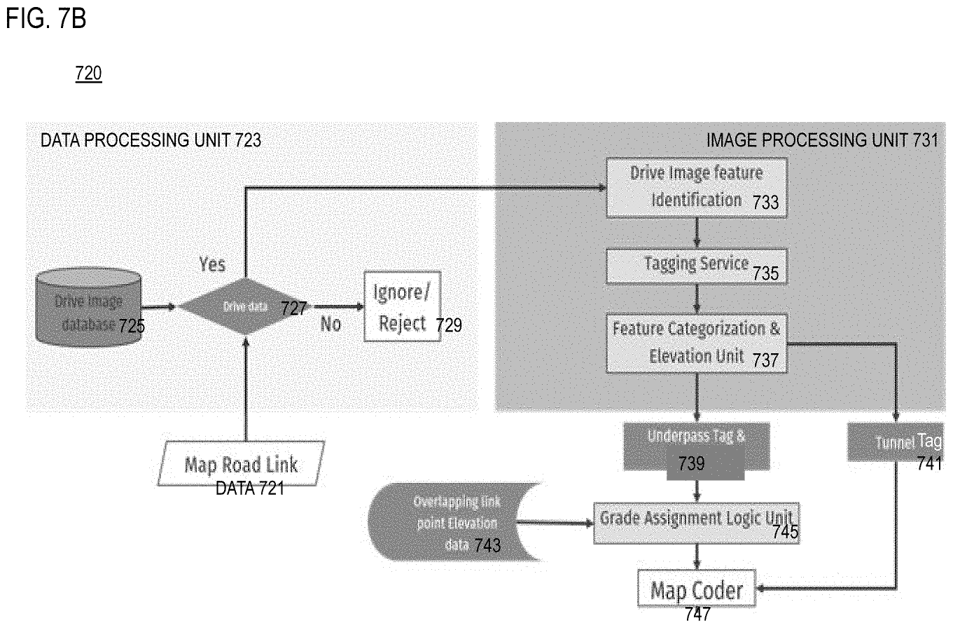

The data processing module 301 can then retrieve the street-level imagery depicting the grade-separated road intersection 102. FIG. 7A are diagrams of example street-level imagery of a two-stack interchange, according to one embodiment. The two-stack interchange has Link A and Link B intersect thereat. The image module 305 can then process the street-level imagery to perform an image segmentation of the street-level imagery into a road image segment, a horizon image segment, a sky image segment, or a combination, and determine or validate the stacking order based on the image segmentation. The road segment can be a lower portion of a street-level image containing a drive path road and nearby object(s). The horizon segment can be a middle portion of the street-level image containing physical object(s), a segment of the drive path road, building(s), tree(s), etc. The sky segment can be a upper portion of the street-level image, usually representing a clear sky and an overhead bridge that is over the drive path road. The sky segment sometimes has partial coverage of tree(s) that can be ignored and removed using machine learning.

For instance, by converting the converting a street-level image 701 (e.g., in color or a gray-scale) into a monochrome image 703, the system 100 can simplify the street-level image 701 and better identify characteristics of the two-stack interchange, such as a stacking order 705: Link B over Link A. For instance, the system 100 can using image segmentation and machine learning on the monochrome image 703 to provide a sky segment 707, a horizontal segment 709, and a road segment 711 that can be process according to a process 720 in FIG. 7B to determine the stacking order 705 as Link B over Link A.

To segment a street-level image into a road image segment, a horizon image segment, and a sky image segment involving a grade-separated road intersection, the system 100 can use the machine learning system 123 to create a machine learning model. For instance, the machine learning system 123 can select respective factors such as one or more summary statistics of drive imagery map objects (e.g., color, sizes, locations, relative distances, etc.), to determine one or more road, sky, intersection structural features. In one embodiment, the machine learning system 123 can select or assign respective weights, correlations, relationships, etc. among the factors, to determine the road, sky, intersection structural features in drive file images. For instance, the machine learning system 123 can continuously provide and/or update the machine learning model (e.g., a SVM, neural network, decision tree, etc.) during training using, for instance, supervised deep convolution networks or equivalents. For instance, such machine learning model can be trained to detect road, sky, intersection structural features from the drive file image data.

In one embodiment, the machine learning system 123 can improve the process for detecting and map-coding a grade-separated road intersection using feedback loops based on, for example, user/vehicle behavior and/or feedback data (e.g., from sensor data, other image data, etc.). In one embodiment, the machine learning system 123 can improve the above-discussed machine learning models using user/vehicle behavior and/or feedback data as training data. For example, the machine learning system 123 can analyze detected/verified grade-separated road intersection and attribute data, missed grade-separated road intersection and attribute data, etc. to determine and to improve upon the performance of the machine learning models.

FIG. 7B is a diagram illustrating an example process 720 for detecting and coding a grade-separated road intersection based on street-level imagery, according to one embodiment. For instance, the system 100 can retrieve map road link data 721 from a map database (e.g., the geographic database 121) for a data processing unit 723 to determine road link intersection data. Based on the road link intersection data, the data processing unit 723 can determine whether there is corresponding drive data/file 727 depicting a grade-separated road intersection of interest (e.g., the intersection 102 where two or more road links 101 intersect) in a drive image database 725.

When determining such drive data/file is missing from the drive image database 725, the data processing unit 723 can discard or reject the road link intersection data is in Step 729. When determining such drive data/file 727 is available in the drive image database 725, the data processing unit 723 can the drive data/file 727 retrieve from the drive image database 725, and send the drive data/file 727 to an image processing unit 731 for processing.

The image processing unit 731 can include a drive image feature identification unit 733, a tagging service 735, and a feature categorization and elevation assignment unit 737. The drive image feature identification unit 733 can identify an overhead object or physical structure (e.g., an overhead bridge) in drive image(s) of the drive data/file 727. Based on the identified overhead object in the drive image(s), the tagging service 735 can create tag(s) for the overhead bridge. The feature categorization and elevation assignment unit 737 can categorize feature(s) based on the tag(s) to differentiate a underpass scenario from a tunnel scenario.

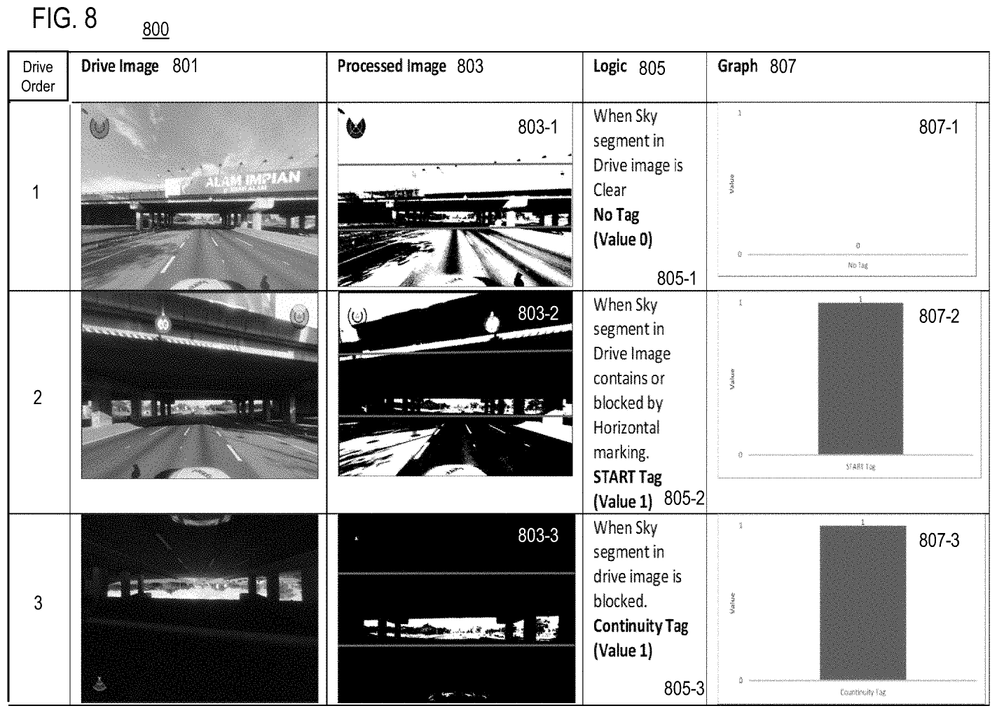

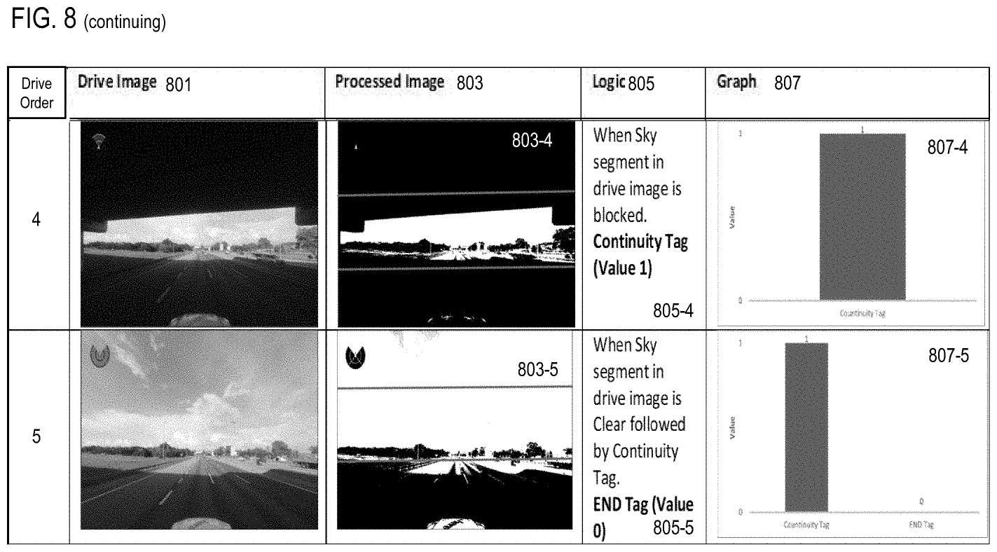

By way of example, the street-level imagery can include a plurality of images captured over a drive sequence/order 1-5, and a stacking order of road links (e.g., an overhead bridge over a drive road path) can be determined based on a change of the image segmentation over the drive sequence/order 1-5, such as the continuity of overhead object tags. The tagging service 735 can create tags based on the presence of the overhead object in the drive images as shown in a table 800 depicted in FIG. 8. FIG. 8 is a diagram illustrating a tagging table, according to one embodiment. For instance, besides the drive sequence/order, the table 800 can include columns: Drive image 801, Process image 803, Logic 805, and Graph 807. In this embodiment, the images in the column of Process image 803 are monochrome images converted form images in the column of Drive image 801.

In the drive sequence/order 1, when the sky segment in a processed image 803-1 is clear, the tagging service 735 does not create tag(s) for the overhead bridge according to a Logic 805-1, so the Value=0 in a Graph 807-1. In the drive sequence/order 2, when the sky segment in a processed image 803-2 contains the sky and is partially blocked by the overhead bridge, the tagging service 735 can start a tag or create a start tag for the overhead bridge according to a Logic 805-2, so the Value=1 in a Graph 807-2. In the drive sequence/order 3, when the sky segment in a processed image 803-3 is fully blocked by the overhead bridge, the tagging service 735 can continue the tag or crate a continuity tag for the overhead bridge according to a Logic 805-3, so the Value=1 in a Graph 807-3. In the drive sequence/order 4, when the sky segment in a processed image 803-4 is still fully blocked by the overhead bridge, the tagging service 735 can continue the tag or the continuity tag for the overhead bridge according to a Logic 805-4, so the Value=1 in a Graph 807-4. In the drive sequence/order 5, when the sky segment in a processed image 803-5 becomes clear followed by the continuity Tag, the tagging service 735 can end the tag or create an end tag for the overhead bridge according to a Logic 805-5, so the Value=0 in a Graph 807-5.

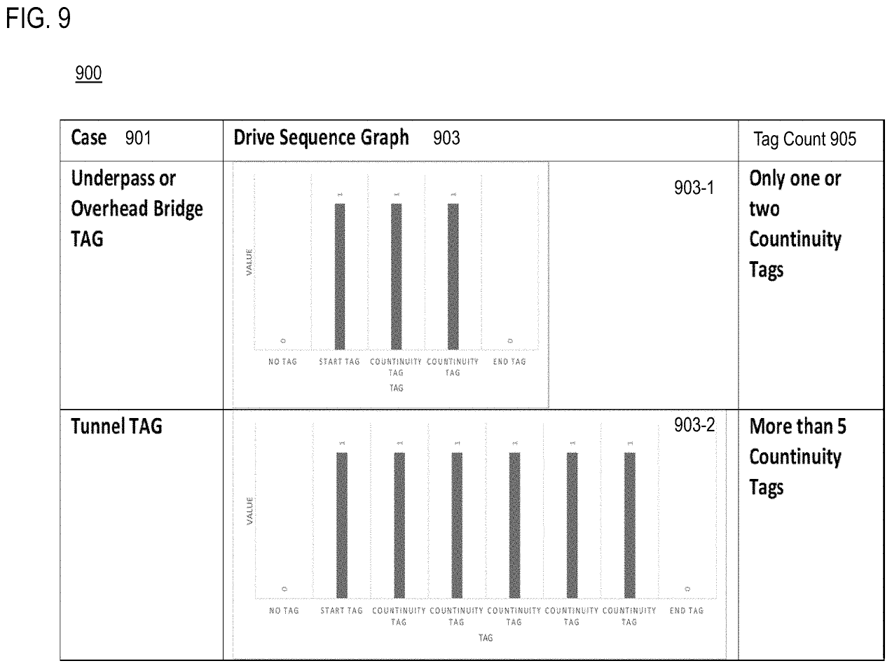

In one embodiment, the feature categorization and elevation assignment unit 737 can categorize the feature(s) based on tag(s) to differentiate an underpass/overpass from a tunnel scenario based on a number of continuity tag detected in a drive sequence. FIG. 9 is a diagram of an example table 900 of junction categories, according to various embodiments. For instance, the table 900 can include columns: Case 901, Graph 903, and Tag count 905. In one embodiment, the system 100 can set only 1-2 continuous continuity tags representing a underpass situation or an overpass bridge. For instance, a graph 903-1 of an overpass in FIG. 9 has two continuous continuity tags, so the junction contains an overpass/underpass and can be assigned with a underpass/overpass tag 739.

In another embodiment, a drive sequence with less than 5 continuous continuity tags (e.g., 2.5 continuous continuity tags) represents a underpass situation or an overpass bridge. By way of example, the system 100 can cascade the graphs 807-1 to 807-5 of FIG. 8 into a graph that includes the start tag, the 2.5 continuity tags, and the end tag, and such graph with 2.5 continuous continuity tags representing the overhead bridge depicted in FIG. 7A and FIG. 8.

In one embodiment, when a drive sequence/order has a continuous continuity tag count more than 5, the junction contains a tunnel and can be assigned with the tunnel tag 741. In another embodiment, when a drive sequence/order has a continuous continuity tag count of 5, the junction also contains a tunnel. For instance, a graph 903-2 of a tunnel in FIG. 9 has five continuous continuity tags. A tunnel length is usually larger than a width of an overhead bridge. As such, the graph 903-3 of a tunnel has more continuity tags than the graph 903-1 of an overhead bridge. After the categorization, the feature categorization and elevation assignment unit 737 can also record and add overlapping link point elevation data 743 to continuity tag data, generate the underpass/overpass tag 739 or the tunnel tag 741, and store the tag(s) 739, 741 in a database (e.g., the geographic database 121).

The junction structure category data (e.g., an underpass/overpass tag, a tunnel tag, etc.) and the overlapping link point elevation data 743 can be sent to a stack/grade level assignment logic unit 745, which can verify the existence of any crossing road link at the junction location. When a crossing road link is identified, the stack/grade level assignment logic unit 745 can allocate a stack value to each road link at the junction, respectively. For a two-stack junction structure (e.g., FIG. 7A), a road link assigned with an underpass tag can receive a stack value of “0” or called “underpass,” while a crossing road link can assigned with a stack value of “1” or called “overpass”. Besides the stack values at the junction, the system 100 can assign the overlapping link point elevation data 743 to each respective road link at the junction. Whenever there is any new drive over an existing underpass tag location in the database (e.g., the geographic database 121), the system 100 can check drive image(s) of a new drive file for tag value(s) and track overlapping link point elevation information. Therefore, the system 100 can verify and/or update stack values.

Once stack level values are assigned for the participating road links at the junction, the stack/grade level assignment logic unit 745 can send the stack level value data to a map coder 747 and/or the mapping platform 107 connected via the communication network 109 to perform necessary coding of the stack level assignment. The stack level assignment can be done at a road link level or at a point location basis, e.g., a location point where all participating links intersect.

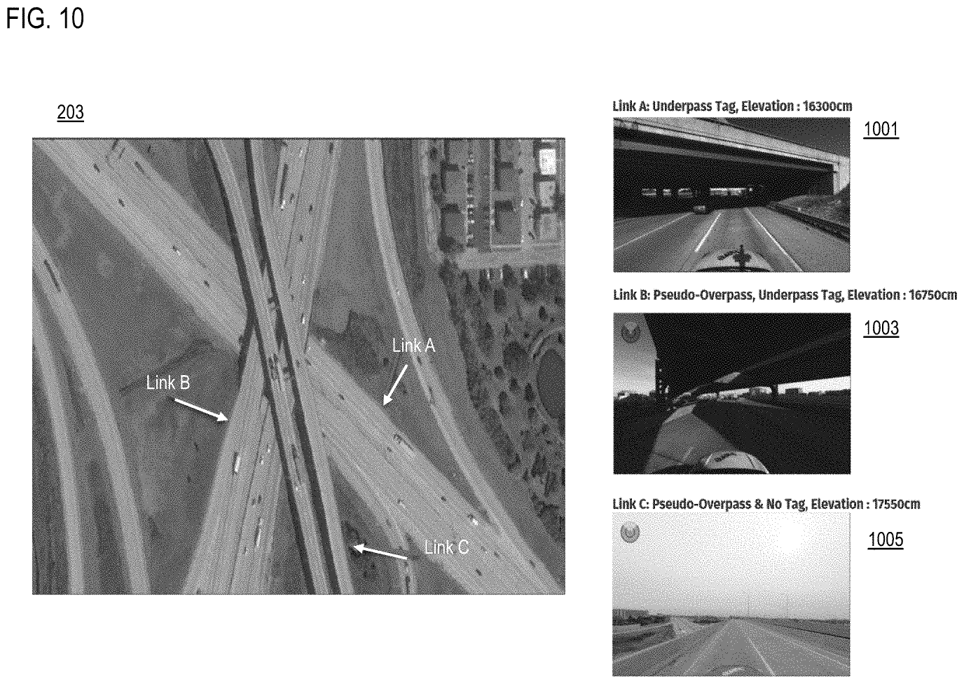

FIG. 10 are diagrams of example drive images of a multi-stack junction structure, according to one embodiment. For this multi-stack junction structure (e.g., the top-down image 203 of the 3-stack interchange 201 in FIG. 2A and again FIG. 10), a first road link (e.g., Link A in the image 203 and a drive image 1001) assigned with a underpass tag can be assigned with a stack value of “0” or called “underpass,” and a subsequent link (e.g., Link B in the image 203 and a drive image 1003) can be assigned with a stack value of “1” or a pseudo-overpass tag. When the second road link (e.g., Link B) above the underpass link (e.g., Link A) is checked for the existence of an overhead object/bridge thereover, the second link can be assigned with a stack value of “0” or called “underpass”. Thus, the second link can be assigned with a pseudo-overpass tag and a underpass tag, resulting in final stack value of “1” or called “underpass-overpass.” A third road link (e.g., Link C in the image 203 and a drive image 1005) can be assigned with “no tag” or “pseudo-overpass tag,” as well as a stack value of “2” or called “overpass.”

Therefore, the system 100 can combine tags with elevation data at a junction/intersection to define multi-stack levels of a multi-stack junction structure as shown in Table 1. As results, the map coder 747 can code Link A as “underpass,” Link B as “underpass-overpass,” and Link C as “overpass.”

Optionally, while assigning the tag values, the system 100 can capture the elevation data (e.g., in centimeters in a file of cm_from_WGS84_ellipsoid of the geographic database 121) of each road link at the multi-stack junction structure, which can be applied to define 4 or more stack levels. For instance, the system 100 can set an elevation difference (e.g., more than 2 meters) to distinguish different stack levels.

TABLE 1

| Road | | Elevation Value (optional) | Elevation | Map |
|---|---|---|---|---|
| Link | TAG | cm_from_WGS84_ellipsoid | Difference | Code |
| Link A | Underpass | 16200 cm | More than | Underpass |
| | Tag | | 2 meters | |
| Link B | Pseudo | 16750 cm | More than | Underpass- |
| | Overpass | | 2 meters | Overpass |
| | Tag & | | | |
| | Underpass | | | |
| | Tag | | | |
| Link C | Pseudo | 17550 cm | More than | Overpass |
| | Overpass | | 2 meters | |
| | Tag or | | | |
| | No Tag | | | |

In another approach (i.e., an elevation approach), the data processing module 301 can retrieve probe data collected from one or more vehicles (e.g., the vehicles 103) traveling the road intersection (e.g., grade-separated road intersection 102). As mentioned, a probe point can include attributes such as: (1) source ID, (2) longitude, (3) latitude, (4) elevation, (5) heading, (6) speed, (7) time, and (8) access type. In one embodiment, the elevation module 311 can then process the probe data to determine elevation data for the two or more road links, and determine or validate the stacking order based on the elevation data.

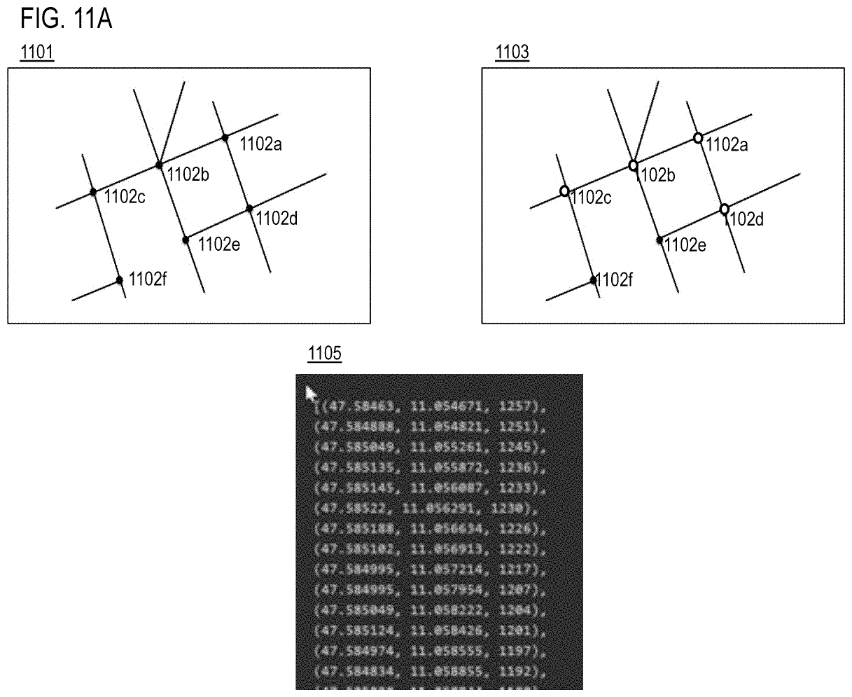

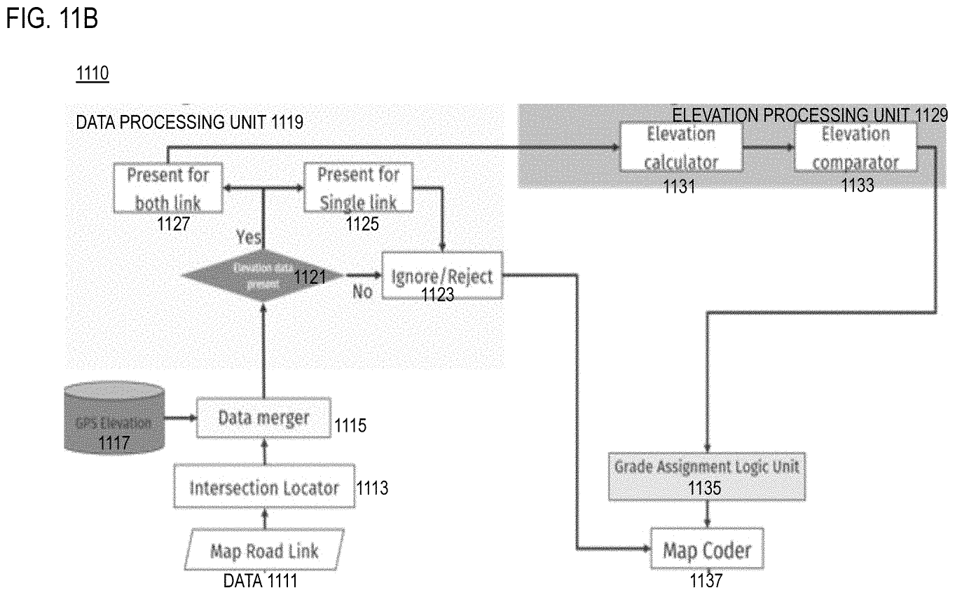

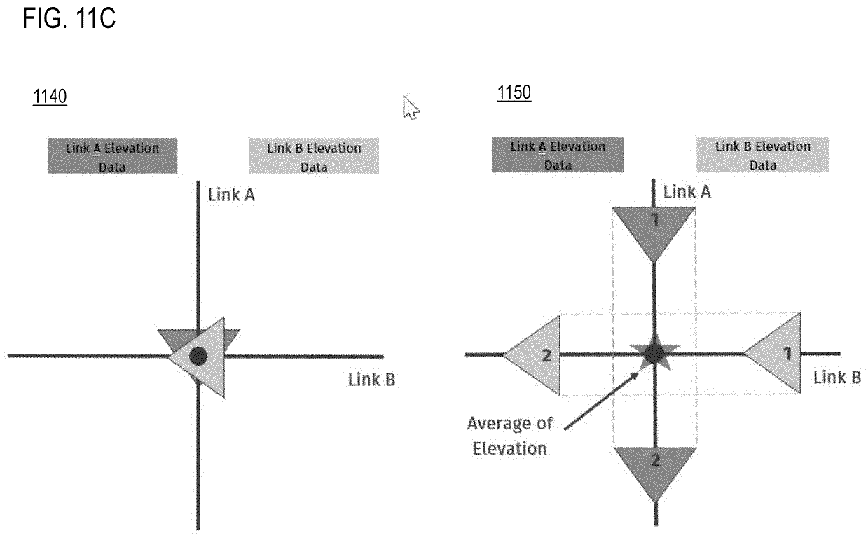

FIG. 11A are diagrams of an elevation approach, according to one embodiment. For instance, a diagram 1101 shows road links intersect at junctions 1102a-1102f. A diagram 1103 shows only intersecting link junctions 1102a-1102d with road links of elevation values (e.g., derived from probe data and/or vehicle location sensor data). In another embodiment, a diagram 1105 shows example elevation data derived from vehicle location sensor data (e.g., GPS data) in a format: (Latitude, Longitude, Elevation) that can be process according to a process 1110 in FIG. 11B.

FIG. 11B is a diagram illustrating the example process 1110 for detecting and coding a grade-separated road intersection based on elevation data, according to one embodiment. For instance, the system 100 can retrieve map road link data 1111 from a map database (e.g., the geographic database 121) for an intersection locator 1113 to determine road link intersection data, and send the road link intersection data to a data processing unit 1119.

In one embodiment, the intersection locator 1113 can process the probe data using computer software to tag a location where two or more road links (e.g., the road links in the diagram 1101) intersecting at grade-separated road intersections (e.g., the junctions 1102a-1102d in the diagram 1103). For instance, the intersection locator 1113 can consider only those junctions/intersections where a number of participating links is equal to or more than 4. In another embodiment, the intersection locator 1113 working in conjunction with a data merger 1115 to merge the vehicle location sensor data with elevation data 1117. The merged data can have none, one or more road elevation points for each road link of a junction.

The merged data is sent to a data processing unit 1119 to determine whether there is elevation data (e.g., from the geographic database 121) available for road links joining at a junction/intersection in Step 1121. When determining such elevation data is unavailable for any of the road links, the data processing unit 1119 can discard or reject the respective road link intersection is in Step 1123. When determining such elevation data is available for only one of the road links in Step 1125, the data processing unit 1119 can also discard or reject the respective road link intersection is in Step 1123. When determining such elevation data is available for only two or more of the road links in Step 1127, the data processing unit 1119 can send the merged data of the respective road link intersection to an elevation processing unit 1129.

Table 2 shows example outputs of the data processing unit 1119 for a 2-stack junction.

TABLE 2

| | | | Elevation | Elevation | Elevation |
|---|---|---|---|---|---|
| | Link | Link | for link A | for link B | Check Output |
| Case 1 | A | B | Present | Present | Accept |
| Case 2 | A | B | Present | Absent | Reject |
| Case 3 | A | B | Absent | Present | Reject |
| Case 4 | A | B | Absent | Absent | Reject |

The elevation processing unit 1129 can include as elevation calculator 1131 and an elevation comparator 1133 to perform at least two operations. One is to calculate the mean elevation for a road link, and second is to calculate an elevation difference and compare it with a standard difference value to assign a stack level value.

FIG. 11C are diagrams of example cases for calculating an junction elevation difference of road links, according to various embodiments. In one embodiment, the elevation calculator 1131 can calculate an elevation difference of road links at a junction in an idle case as shown in a diagram 1140 in FIG. 11C. In an idle case, an elevation difference of Link A and Link B is measured at the same or common point. For Link A, its elevation at the intersection is the elevation value at the point. For Link B, its elevation at the intersection is also the elevation value at the point. The elevation calculator 1131 can then compare the elevation difference with a pre-defined (e.g., standard) elevation difference value. The idle case scenario rarely occurs.

In a real case as shown in a diagram 1150 in FIG. 11C, two road link elevation points cannot be the same, and hence the elevation calculator 1131 can calculate a difference between their elevations using average elevations for respective road links. For average elevation calculation, the elevation calculator 1131 can consider the first nearest elevation point on a link in both directions from the junction location where two links intersect with each other. This will give the average elevation for a respective road link. For Link A, its average elevation for the intersection can be (Elevation value at point 1+Elevation value at point 2)/2. For Link B, its average elevation for the intersection can be (Elevation value at point 1+Elevation value at point 2)/2.

The elevation comparator 1133 can perform arithmetic calculation and provide an elevation difference of two links. For instance, the elevation comparator 1133 can compare the elevation difference of the two links to a standard elevation difference value (e.g., 2 meters) to build logic for assigning road stack level values as shown in Table 3.

TABLE 3

| | Average | Average | Elevation | |
|---|---|---|---|---|
| | Elevation | Elevation | Difference | Processing |
| Case 1 | A | B | Zero | Ignore |
| Case 2 | A | B | Less Than | Ignore |
| | | | 2 meters | |
| Case 3 | A | B | Equal to | Ignore |
| | | | 2 meters | |
| Case 4 | A | B | Greater than | Stack/Grade |
| | | | 2 meters | Assignment |
| | | | | Logic |
| | | | | Unit 1135 |

In one embodiment, the elevation processing unit 1129 can ignore junctions with an road link elevation difference zero, less than 2 meters, or equal to 2 meters, and send junction(s) with a road link elevation difference more than 2 meters to a stack/grade level assignment unit 1135 based on Table 3.

The stack/grade level assignment unit 1135 can assign a stack level value to a link participating/intersecting at the junction with a road link elevation difference more than 2 meters based on the pre-defined criteria and logic. For instance, the criteria for multi-stack level coding can be: For a two-stack junction structure (e.g., FIG. 7A), a road link assigned with an underpass tag can receive a stack value of “0” or called “underpass,” while a crossing road link can assigned with a stack value of “1” or called “overpass”. As results, q map coder 1137 can code Link A as “underpass,” and Link B as “overpass.”

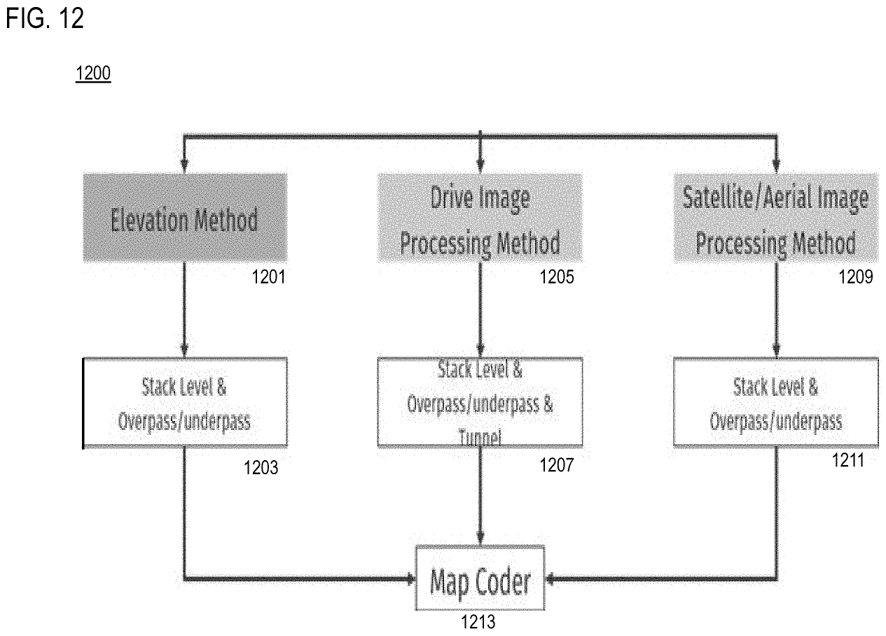

In summary, the stack/grade level assignment unit 225 can assign stack level values based on the top-down image approach (e.g., FIG. 2B), the street level imagery approach (e.g., FIG. 7B), and/or the elevation approach (e.g., FIG. 11B). FIG. 12 is a diagram 1200 of example hybrid approaches for determining a stacking order at a junction, according to various embodiments. The diagram 1200 lists an elevation method 1201 that can assign stack level values to road links joining at a overpass/underpass in Step 1203 (e.g., based on the elevation approach in FIG. 11B), a drive image processing method 1205 that can assign stack level values to road links joining at a overpass/underpass or a tunnel in Step 1207 (e.g., based on the street level imagery approach in FIG. 7B), and a satellite/aerial image processing method 1209 that can assign stack level values to road links joining at a overpass/underpass in Step 1211 (e.g., based on the top-down image approach in FIG. 2B). Therefore, a map coder 1213 can code the junction/intersection and its attributes in a map (e.g., a digital map), a geographic database, etc., based one or more of the listed methods/approaches as a final output.

In some embodiments, the system 100 can use a hybrid approach/methods (which combines two or more of the approaches/methods) as shown in FIG. 12 to deliver more accurate data (e.g., a stacking order) for different real world stack junction/interchange case scenarios as shown in Table 4.

TABLE 4

| | Stack Level | | | | Overpass/ |
|---|---|---|---|---|---|
| | Assignment | | | | Underpass |
| Case | Criteria | Processing | Logic | Stack Level Value | Attribute |
| Case 1 | Multi-Stack | Elevation | Elevation of Link A < | Link A Stack | Junction |
| | Level (e.g., | calculator | Elevation of Link B < | Level value = 0 | Meeting Multi |
| | FIG. 2A) | | Elevation of Link C | Link B Stack | Stack level |
| | Note: 3 | | | Level value = 1 | criteria with |
| | or more | | | Link C Stack | Elevation data |
| | participating | | | Level value = 2 | Link A = 0 = |
| | link at | | | | Underpass |
| | Junction or | | | | Link B = 1 = |
| | intersection | | | | Underpass/ |
| | | | | | Overpass |
| | | | | | Link C = 2 = |
| | | | | | Overpass |
| | | Drive | Link A underpass | Link A Stack | Junction |
| | | Image | Tag < Link B pseudo- | Level value = 0 | Meeting Multi |
| | | processing | overpass Tag & | Link B Stack | Stack level |
| | | unit | underpass Tag < | Level value = 1 | criteria with |
| | | | Link C pseudo- | Link C Stack | Drive image |
| | | | overpass Tag | Level value = 2 | processing data |
| | | | & No Tag | | Link A = 0 = |
| | | | | | Underpass |
| | | | | | Link B = 1 = |
| | | | | | Underpass/ |
| | | | | | Overpass |
| | | | | | Link C = 2 = |
| | | | | | Overpass |
| | | Satellite/ | Link C is continuous | Link A Stack | Junction |
| | | Aerial image | with or without | Level value = 0 | Meeting Multi |
| | | processing | lateral shadow | Link B Stack | Stack level |
| | | | Link B is non | Level value = 1 | criteria with |
| | | | continuous with | Link C Stack | Satellite/Aerial |
| | | | lateral shadow | Level value = 2 | Image |
| | | | Lick A is not | | processing data |
| | | | continuous without | | Link A = 0 = |
| | | | lateral shadow | | Underpass |
| | | | | | Link B = 1 = |
| | | | | | Underpass/ |
| | | | | | Overpass |
| | | | | | Link C = 2 = |
| | | | | | Overpass |
| Case 2 | Two-Stack | Elevation | Elevation of Link A < | Link A Stack | Junction |
| | Level | calculator | Elevation of Link B | Level value = 0 | Meeting Two |
| | (Except | | | Link B Stack | Stack level |
| | Water | | | Level value = 1 | criteria with |
| | Feature link | | | | Elevation data |
| | and | | | | Link A = 0 = |
| | Polygon, | | | | Underpass |
| | e.g., FIG. 5) | | | | Link B = 1 = |
| | | | | | Overpass |
| | | Drive | Link A underpass | Link A Stack | Junction |
| | | Image | Tag < Link B | Level value = 0 | Meeting Multi |
| | | processing | overpass Tag | Link B Stack | Stack level |
| | | unit | | Level value = 1 | criteria with |
| | | | | | Drive image |
| | | | | | processing data |
| | | | | | Link A = 0 = |
| | | | | | Underpass |
| | | | | | Link B = 1 = |
| | | | | | Overpass |
| | | Satellite | Link A is not | Link A Stack | Junction |
| | | image | continuous without | Level value = 0 | Meeting Two |
| | | processing | lateral shadow | Link B Stack | Stack level |
| | | | Link B is continuous | Level value = 1 | criteria with |
| | | | with or without | | Satellite/Aerial |
| | | | Lateral shadow | | Image |
| | | | | | processing data |
| | | | | | Link A = 0 = |
| | | | | | Underpass |
| | | | | | Link B = 1 = |
| | | | | | Overpass |
| Case 3 | Road and | Elevation | Elevation present for | Link A Stack | Junction |
| | water | calculator | link B and link A | Level value = −1 | Meeting Road |
| | feature | | should be pre | Link B Stack | and Water |
| | Stack Level, | | detected or coded | Level value = 0 | feature Stack |
| | For ferry | | with Non-Navigable | | level criteria |
| | route (e.g., | | features like river, | | with Elevation |
| | FIG. 6) | | lake, ocean, etc. | | data |
| | | | | | Link A = −1 = |
| | | | | | Underpass |
| | | | | | Link B = 0 = |
| | | | | | Overpass |
| | | Drive | No Tag for link B | Link A Stack | Junction |
| | | Image | and link A should be | Level value = −1 | Meeting Road |
| | | processing | pre detected or coded | Link B Stack | and Water |
| | | unit | with Non-Navigable | Level value = 0 | feature Stack |
| | | | features like river, | | level criteria |
| | | | lake, ocean, etc. | | with Drive |
| | | | | | Image |
| | | | | | processing data |
| | | | | | Link A = −1 = |
| | | | | | Underpass |
| | | | | | Link B = 0 = |
| | | | | | Overpass |
| | | Satellite | Link A non- | Link A Stack | Junction |
| | | image | continuous road | Level value = −1 | Meeting Road |
| | | processing | feature (may be | Link B Stack | and Water |
| | | | water, lake, ocean, | Level value = 0 | feature Stack |
| | | | Subway etc.) | | level criteria |
| | | | Link B is continuous | | with |
| | | | with or without | | Satellite/Aerial |
| | | | shadow | | Image |
| | | | | | processing data |
| | | | | | Link A = −1 = |
| | | | | | Underpass |
| | | | | | Link B = 0 = |
| | | | | | Overpass |

Table 4 can list map attributes derived from the above-described embodiments, such as an overpass that can be a road (including ramp, bridge, etc.) passing over another road at a ground level, a underpass that can be a road (e.g., a tunnel) passing through a structure or object having another road structure over it at a certain vertical height, a bridge Location, and stack level coding including road passing over or under water bodies.

In one embodiment, in step 407, the output module 313 can providing the stacking order as an output. In another embodiment, the output module 313 can store the stacking order as map data of a geographic database (e.g., the geographic database 121). For example, the map data output may be used in connection with one or more navigation services (e.g., services 117a-117n) to improve the navigation of one or more vehicles 103 (e.g., an autonomous vehicle) traveling through the road links 101.

For instance, the output module 313 can generate a network geometry topology including grade-separated road intersection path data. For the purpose of illustration herein, the network geometry topology defines the arrangement of and/or relationship between the various links and/or nodes surrounding the grade-separated road intersection. As such, the network geometry topology may be depicted physically or logically and maintained as a dataset in association with a unique identifier of the grade-separated road intersection via the geographic database 121. The grade-separated road intersection identifier may be established by content providers 119, the mapping platform 107 or the geographic database 121 for enabling subsequent cross referencing, matching and validation of the map data, as well as supporting navigation services.

The above-discussed embodiments can detect and automate road stack level coding, overpass and underpass attribute coding, etc., for mapping, navigation, and other location-based services.

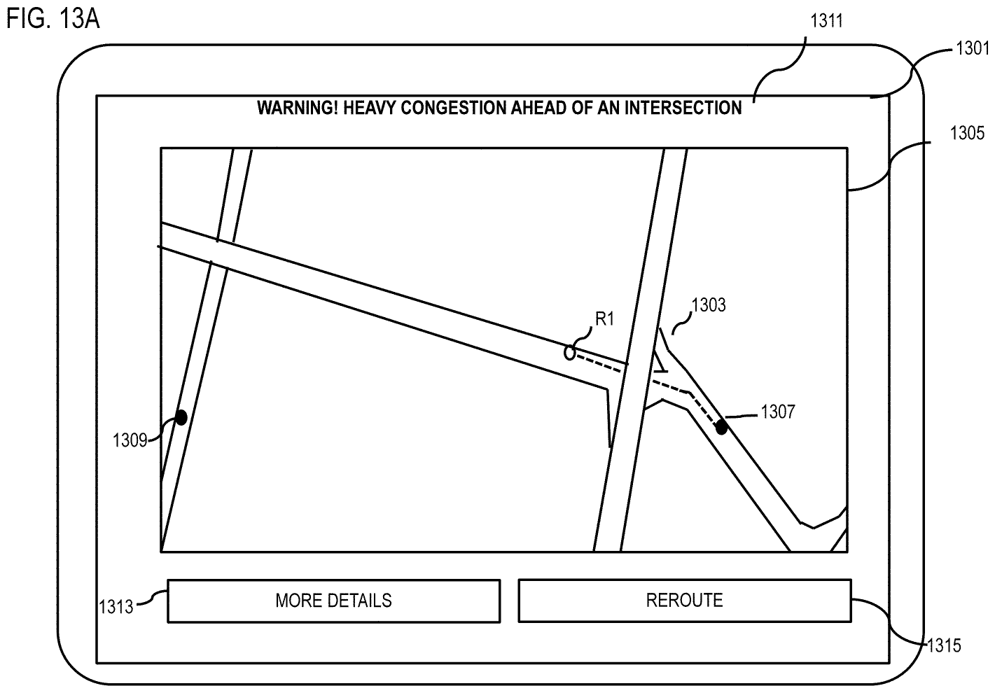

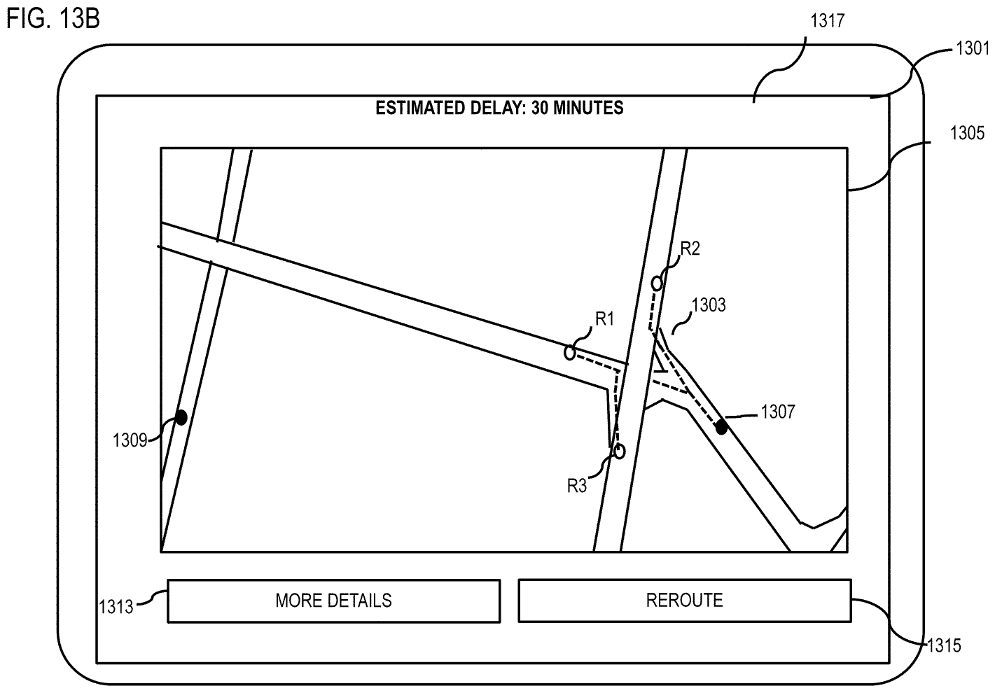

By way of example, FIGS. 13A-13B are diagrams of example user interfaces for routing via a congested grade-separated road intersection, according to various embodiments. Referring to FIG. 13A, in one embodiment, the system 100 can generate a user interface (UI) 1301 (e.g., using a navigation application 113) for a UE 111 (e.g., a mobile device, an embedded navigation system, etc.) that can enable a user (e.g., a driver of a vehicle 103) or a vehicle 103 (e.g., an autonomous vehicle) to navigate via a congested grade-separated road intersection 1303 while traveling in a road network. In one instance, the system 100 can generate the UI 1301 such that it includes a map 1305, a current/congested route R1 leading from a current location 1307 via the grade-separated road intersection 1303 to a destination 1309, and an alert 1311: “Warning! Heavy Congestion ahead of an intersection.” In this example, the system 100 can also generate the UI 1301 such that it includes an input 1313 (e.g., “More Details”) and an input 1315 (e.g., “Reroute”). For example, a user can interact with the UI 1301, the various inputs described with respect to FIGS. 13A and 13B (e.g., inputs 1313 and 1315), or a combination thereof via one or more physical interactions (e.g., a touch, a tap, a gesture, typing, etc.), one or more voice commands (e.g., “show estimated delay,” “flag road closure,” etc.), or a combination thereof.

In one instance, when a user interacts with the input 1313 (e.g., “More Details”), the system 100 can generate the UI 1301 such that it shows an alert 1317: “Estimated Delay: 30 minutes,” as depicted in FIG. 13B. In another example, when the user interacts with the input 1315 (e.g., “Reroute”), the system 100 can generate the UI 1301 based on junction attributes (including a stacking order) obtained based on the above-described embodiments, such that it shows one or more new routes R2, R3 that can enable the user and/or a vehicle 103 to bypass the congested grade-separated road intersection 1303. It is contemplated that in this instance, the system 100 can determine or detect one or more actions by a user (e.g., an eye gaze) and automatically confirm the interaction. This is particularly useful in the case of a passenger in an autonomous or semi-autonomous vehicle 103.

Returning to FIG. 1, in one embodiment, the mapping platform 107 performs the process for detecting and coding a grade-separated road intersection based on image data as discussed with respect to the various embodiments described herein. For example, the mapping platform 107 can generate road segment related features for machine learning solutions (e.g., using the machine learning system 123).

In one embodiment, the mapping platform 107 has connectivity over the communications network 109 to the services platform 115 (e.g., an OEM platform) that provides the services 117a-117n (also collectively referred to herein as services 117) (e.g., probe and/or sensor data collection services). By way of example, the services 117 may also be other third-party services and include mapping services, navigation services, traffic incident services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services platform 115 uses the output (e.g. whether a road segment is closed or not) of the mapping platform 107 to provide services such as navigation, mapping, other location-based services, etc.

In one embodiment, the mapping platform 107 may be a platform with multiple interconnected components. The mapping platform 107 may include multiple servers, intelligent networking devices, computing devices, components, and corresponding software for providing parametric representations of lane lines. In addition, it is noted that the mapping platform 107 may be a separate entity of the system 100, a part of the services platform 115, a part of the one or more services 117, or included within a vehicle 103 (e.g., an embedded navigation system).

In one embodiment, content providers 119 may provide content or data (e.g., including road closure reports, probe data, expected vehicle volume data, etc.) to the mapping platform 107, the UEs 111, the applications 113, the services platform 115, the services 117, the geographic database 121, and the vehicles 103. The content provided may be any type of content, such as map content, textual content, audio content, video content, image content, etc. In one embodiment, the content providers 119 may provide content regarding the expected frequency of vehicles 103 on the digital map or link as well as content that may aid in localizing a vehicle path or trajectory on a digital map or link (e.g., to assist with determining actual vehicle volumes on a road network). In one embodiment, the content providers 119 may also store content associated with the mapping platform 107, the services platform 115, the services 117, the geographic database 121, and/or the vehicles 103. In another embodiment, the content providers 119 may manage access to a central repository of data, and offer a consistent, standard interface to data, such as a repository of the geographic database 121.

By way of example, the UEs 111 are any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that a UE 111 can support any type of interface to the user (such as “wearable” circuitry, etc.). In one embodiment, a UE 111 may be associated with a vehicle 103 (e.g., a mobile device) or be a component part of the vehicle 103 (e.g., an embedded navigation system). In one embodiment, the UEs 111 may include the mapping platform 107 to detect and map-code a grade-separated road intersection based on probes and image data.

In one embodiment, as mentioned above, the vehicles 103, for instance, are part of a probe-based system for collecting probe data for detecting actual and expected vehicle volumes on a road network and/or measuring traffic conditions in the road network (e.g., free flow traffic versus a road closure). In one embodiment, each vehicle 103 is configured to report probe data as probes, which are individual data records collected at a point in time that records telemetry data for that point in time. In one embodiment, the probe ID can be permanent or valid for a certain period of time. In one embodiment, the probe ID is cycled, particularly for consumer-sourced data, to protect the privacy of the source.

In one embodiment, a probe point can include attributes such as: (1) source ID, (2) longitude, (3) latitude, (4) heading, (5) speed, and (6) time. The list of attributes is provided by way of illustration and not limitation. Accordingly, it is contemplated that any combination of these attributes or other attributes may be recorded as a probe point. For example, attributes such as altitude (e.g., for flight capable vehicles or for tracking non-flight vehicles in the altitude domain), tilt, steering angle, wiper activation, etc. can be included and reported for a probe point. In one embodiment, the vehicles 103 may include vehicle sensors 105 for reporting measuring and/or reporting attributes. The attributes can also be any attribute normally collected by an on-board diagnostic (OBD) system of the vehicle 103, and available through an interface to the OBD system (e.g., OBD II interface or other similar interface).

The probes can be reported from the vehicles 103 in real-time, in batches, continuously, or at any other frequency requested by the system 100 over, for instance, the communication network 109 for processing by the mapping platform 107. The probes also can be map matched to specific road links stored in the geographic database 121. In one embodiment, the system 100 (e.g., via the mapping platform 107) generates vehicle paths or trajectories from the observed and expected frequency of probes for an individual probe as discussed with respect to the various embodiments described herein so that the probe traces represent a travel trajectory or vehicle path of the probe through a road network.

In one embodiment, as previously stated, the vehicles 103 are configured with various sensors (e.g., vehicle sensors 105) for generating or collecting probe data, sensor data, related geographic/map data, etc. In one embodiment, the sensed data represents sensor data associated with a geographic location or coordinates at which the sensor data was collected (e.g., a latitude and longitude pair). In one embodiment, the probe data (e.g., stored in the geographic database 121) includes location probes collected by one or more vehicle sensors 105. By way of example, the vehicle sensors 105 may include a RADAR system, a LiDAR system, global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data, an audio recorder for gathering audio data, velocity sensors mounted on a steering wheel of the vehicles 103, switch sensors for determining whether one or more vehicle switches are engaged, and the like. Though depicted as automobiles, it is contemplated the vehicles 103 can be any type of vehicle manned or unmanned (e.g., cars, trucks, buses, vans, motorcycles, scooters, drones, etc.) that travels through road segments of a road network (e.g., road network).

Other examples of sensors 105 of a vehicle 103 may include light sensors, orientation sensors augmented with height sensors and acceleration sensor (e.g., an accelerometer can measure acceleration and can be used to determine orientation of the vehicle), tilt sensors to detect the degree of incline or decline of a vehicle 103 along a path of travel, moisture sensors, pressure sensors, etc. In a further example embodiment, vehicle sensors 105 about the perimeter of a vehicle 103 may detect the relative distance of the vehicle 103 from a physical divider, a lane line of a link or roadway, the presence of other vehicles, pedestrians, traffic lights, potholes and any other objects, or a combination thereof. In one scenario, the vehicle sensors 105 may detect weather data, traffic information, or a combination thereof. In one embodiment, a vehicle 103 may include GPS or other satellite-based receivers to obtain geographic coordinates from satellites 125 for determining current location and time. Further, the location can be determined by visual odometry, triangulation systems such as A-GPS, Cell of Origin, or other location extrapolation technologies.

In one embodiment, the UEs 111 may also be configured with various sensors (not shown for illustrative convenience) for acquiring and/or generating probe data and/or sensor data associated with a vehicle 103, a driver, a passenger, other vehicles, conditions regarding the driving environment or roadway, etc. For example, such sensors may be used as GPS receivers for interacting with the one or more satellites 125 to determine and track the current speed, position, and location of a vehicle 103 travelling along a link or road segment. In addition, the sensors may gather tilt data (e.g., a degree of incline or decline of the vehicle during travel), motion data, light data, sound data, image data, weather data, temporal data and other data associated with the vehicles 103 and/or UEs 111. Still further, the sensors may detect local or transient network and/or wireless signals, such as those transmitted by nearby devices during navigation of a vehicle along a roadway (Li-Fi, near field communication (NFC)) etc.

It is noted therefore that the above described data may be transmitted via the communication network 109 as probe data (e.g., GPS probe data) according to any known wireless communication protocols. For example, each UE 111, application 113, user, and/or vehicle 103 may be assigned a unique probe identifier (probe ID) for use in reporting or transmitting the probe data collected by the vehicles 103 and/or UEs 111. In one embodiment, each vehicle 103 and/or UE 111 is configured to report probe data as probes, which are individual data records collected at a point in time that records telemetry data.

In one embodiment, the mapping platform 107 retrieves aggregated probes gathered and/or generated by the vehicle sensors 105 and/or the UEs 111 resulting from the travel of the UEs 111 and/or vehicles 103 on a road segment of a road network (e.g., the road network). In one instance, the geographic database 121 stores a plurality of probes and/or trajectories generated by different vehicle sensors 105, UEs 111, applications 113, vehicles 103, etc. over a period while traveling in a large, monitored area (e.g., the road network). A time sequence of probes specifies a trajectory—i.e., a path traversed by a UE 111, application 113, vehicle 103, etc. over the period.

In one embodiment, the communication network 109 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the vehicles 103, vehicle sensors 105, mapping platform 107, UEs 111, applications 113, services platform 115, services 117, content providers 119, and/or satellites 125 communicate with each other and other components of the system 100 using well known, new or still developing protocols. In this context, a protocol includes a set of rules defining how the network nodes within the communication network 109 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

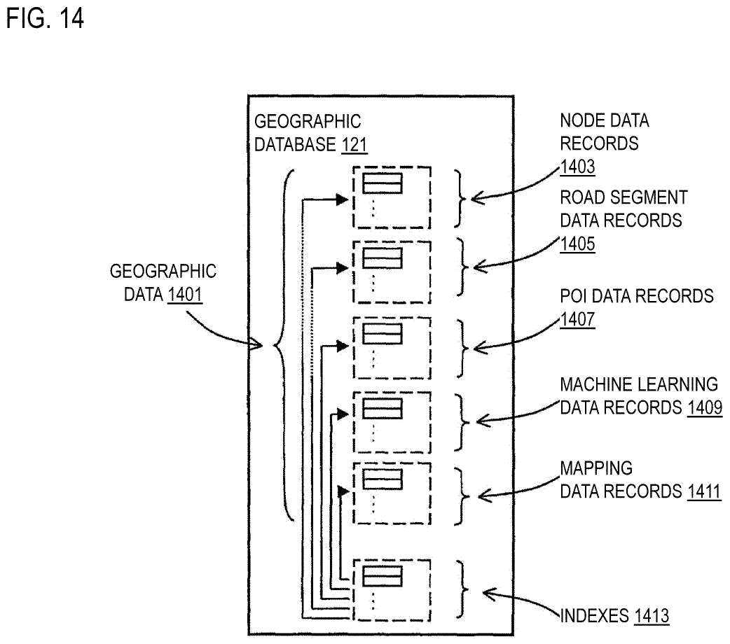

FIG. 14 is a diagram of a geographic database (such as the database 121), according to one embodiment. In one embodiment, the geographic database 121 includes geographic data 1401 used for (or configured to be compiled to be used for) mapping and/or navigation-related services, such as for video odometry based on the parametric representation of lanes include, e.g., encoding and/or decoding parametric representations into lane lines. In one embodiment, the geographic database 121 include high resolution or high definition (HD) mapping data that provide centimeter-level or better accuracy of map features. For example, the geographic database 121 can be based on Light Detection and Ranging (LiDAR) or equivalent technology to collect billions of 3D points and model road surfaces and other map features down to the number lanes and their widths. In one embodiment, the mapping data (e.g., mapping data records 1411) capture and store details such as the slope and curvature of the road, lane markings, roadside objects such as signposts, including what the signage denotes. By way of example, the mapping data enable highly automated vehicles to precisely localize themselves on the road.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 121.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 121 follows certain conventions. For example, links do not cross themselves and do not cross each other except at a node. Also, there are no duplicated shape points, nodes, or links. Two links that connect each other have a common node. In the geographic database 121, overlapping geographic features are represented by overlapping polygons. When polygons overlap, the boundary of one polygon crosses the boundary of the other polygon. In the geographic database 121, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 121 includes node data records 1403, road segment or link data records 1405, POI data records 1407, intersection data records 1409, mapping data records 1411, and indexes 1414, for example. More, fewer or different data records can be provided. In one embodiment, additional data records (not shown) can include cartographic (“carto”) data records, routing data, and maneuver data. In one embodiment, the indexes 1414 may improve the speed of data retrieval operations in the geographic database 121. In one embodiment, the indexes 1414 may be used to quickly locate data without having to search every row in the geographic database 121 every time it is accessed. For example, in one embodiment, the indexes 1414 can be a spatial index of the polygon points associated with stored feature polygons.

In exemplary embodiments, the road segment data records 1405 are links or segments representing roads, streets, or paths, as can be used in the calculated route or recorded route information for determination of one or more personalized routes. The node data records 1403 are end points (such as intersections) corresponding to the respective links or segments of the road segment data records 1405. The road link data records 1405 and the node data records 1403 represent a road network, such as used by vehicles, cars, and/or other entities. Alternatively, the geographic database 121 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 121 can include data about the POIs and their respective locations in the POI data records 1407. The geographic database 121 can also include data about places, such as cities, towns, or other communities, and other geographic features, such as bodies of water, mountain ranges, etc. Such place or feature data can be part of the POI data records 1407 or can be associated with POIs or POI data records 1407 (such as a data point used for displaying or representing a position of a city). In one embodiment, certain attributes, such as lane marking data records, mapping data records and/or other attributes can be features or layers associated with the link-node structure of the database.

In one embodiment, the geographic database 121 can also include intersection data records 1409 for storing junction/intersection location data, junction/intersection image data (e.g., top-down images, street-level imagery, etc.), road link elevation data at junctions, stacking order data, training data, prediction models, annotated observations, computed featured distributions, sampling probabilities, and/or any other data generated or used by the system 100 according to the various embodiments described herein. By way of example, the intersection data records 1409 can be associated with one or more of the node records 1403, road segment records 1405, and/or POI data records 1407 to support localization or visual odometry based on the features stored therein and the corresponding estimated quality of the features. In this way, the intersection data records 1409 can also be associated with or used to classify the characteristics or metadata of the corresponding records 1403, 1405, and/or 1407.

In one embodiment, as discussed above, the mapping data records 1411 model road surfaces and other map features to centimeter-level or better accuracy. The mapping data records 1411 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the mapping data records 1411 are divided into spatial partitions of varying sizes to provide mapping data to vehicles 103 and other end user devices with near real-time speed without overloading the available resources of the vehicles 103 and/or devices (e.g., computational, memory, bandwidth, etc. resources).

In one embodiment, the mapping data records 1411 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the mapping data records 1411.

In one embodiment, the mapping data records 1411 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 121 can be maintained by the content provider 119 in association with the services platform 115 (e.g., a map developer). The map developer can collect geographic data to generate and enhance the geographic database 121. There can be different ways used by the map developer to collect data. These ways can include obtaining data from other sources, such as municipalities or respective geographic authorities. In addition, the map developer can employ field personnel to travel by vehicle (e.g., vehicles 103 and/or user terminals 111) along roads throughout the geographic region to observe features and/or record information about them, for example. Also, remote sensing, such as aerial or satellite photography, can be used.

The geographic database 121 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 103 or a user terminal 111, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for detecting and coding a grade-separated road intersection based on image data may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

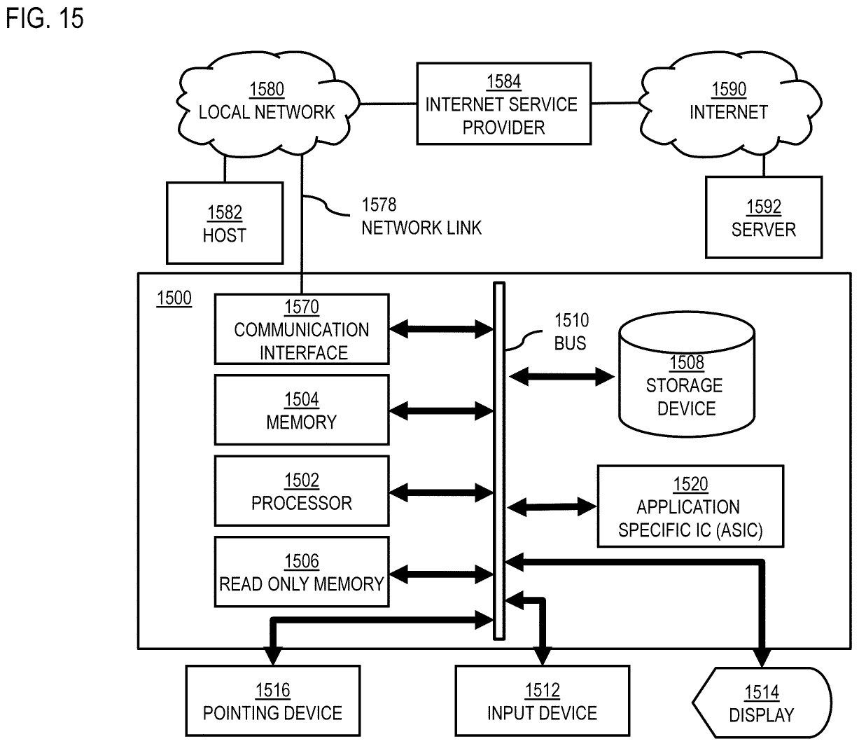

FIG. 15 illustrates a computer system 1500 upon which an embodiment of the invention may be implemented. Computer system 1500 is programmed (e.g., via computer program code or instructions) to detect and code a grade-separated road intersection based on image data as described herein and includes a communication mechanism such as a bus 1510 for passing information between other internal and external components of the computer system 1500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1510 includes one or more parallel conductors of information so that information is transferred quickly among devices coupled to the bus 1510. One or more processors 1502 for processing information are coupled with the bus 1510.

A processor 1502 performs a set of operations on information as specified by computer program code related to detecting and coding a grade-separated road intersection based on image data. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1510 and placing information on the bus 1510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1500 also includes a memory 1504 coupled to bus 1510. The memory 1504, such as a random access memory (RANI) or other dynamic storage device, stores information including processor instructions for detecting and coding a grade-separated road intersection based on image data. Dynamic memory allows information stored therein to be changed by the computer system 1500. RANI allows a unit of information stored at a location called a memory address to be stored and retrieved independently of information at neighboring addresses. The memory 1504 is also used by the processor 1502 to store temporary values during execution of processor instructions. The computer system 1500 also includes a read only memory (ROM) 1506 or other static storage device coupled to the bus 1510 for storing static information, including instructions, that is not changed by the computer system 1500. Some memory is composed of volatile storage that loses the information stored thereon when power is lost. Also coupled to bus 1510 is a non-volatile (persistent) storage device 1508, such as a magnetic disk, optical disk or flash card, for storing information, including instructions, that persists even when the computer system 1500 is turned off or otherwise loses power.

Information, including instructions for detecting and coding a grade-separated road intersection based on image data, is provided to the bus 1510 for use by the processor from an external input device 1512, such as a keyboard containing alphanumeric keys operated by a human user, or a sensor. A sensor detects conditions in its vicinity and transforms those detections into physical expression compatible with the measurable phenomenon used to represent information in computer system 1500. Other external devices coupled to bus 1510, used primarily for interacting with humans, include a display device 1514, such as a cathode ray tube (CRT) or a liquid crystal display (LCD), or plasma screen or printer for presenting text or images, and a pointing device 1516, such as a mouse or a trackball or cursor direction keys, or motion sensor, for controlling a position of a small cursor image presented on the display 1514 and issuing commands associated with graphical elements presented on the display 1514. In some embodiments, for example, in embodiments in which the computer system 1500 performs all functions automatically without human input, one or more of external input device 1512, display device 1514 and pointing device 1516 is omitted.

In the illustrated embodiment, special purpose hardware, such as an application specific integrated circuit (ASIC) 1520, is coupled to bus 1510. The special purpose hardware is configured to perform operations not performed by processor 1502 quickly enough for special purposes. Examples of application specific ICs include graphics accelerator cards for generating images for display 1514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1500 also includes one or more instances of a communications interface 1570 coupled to bus 1510. Communication interface 1570 provides a one-way or two-way communication coupling to a variety of external devices that operate with their own processors, such as printers, scanners and external disks. In general the coupling is with a network link 1578 that is connected to a local network 1580 to which a variety of external devices with their own processors are connected. For example, communication interface 1570 may be a parallel port or a serial port or a universal serial bus (USB) port on a personal computer. In some embodiments, communications interface 1570 is an integrated services digital network (ISDN) card or a digital subscriber line (DSL) card or a telephone modem that provides an information communication connection to a corresponding type of telephone line. In some embodiments, a communication interface 1570 is a cable modem that converts signals on bus 1510 into signals for a communication connection over a coaxial cable or into optical signals for a communication connection over a fiber optic cable. As another example, communications interface 1570 may be a local area network (LAN) card to provide a data communication connection to a compatible LAN, such as Ethernet. Wireless links may also be implemented. For wireless links, the communications interface 1570 sends or receives or both sends and receives electrical, acoustic or electromagnetic signals, including infrared and optical signals, that carry information streams, such as digital data. For example, in wireless handheld devices, such as mobile telephones like cell phones, the communications interface 1570 includes a radio band electromagnetic transmitter and receiver called a radio transceiver. In certain embodiments, the communications interface 1570 enables connection to the communication network 109 for detecting and coding a grade-separated road intersection based on image data.

The term computer-readable medium is used herein to refer to any medium that participates in providing information to processor 1502, including instructions for execution. Such a medium may take many forms, including, but not limited to, non-volatile media, volatile media and transmission media. Non-volatile media include, for example, optical or magnetic disks, such as storage device 1508. Volatile media include, for example, dynamic memory 1504. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 1578 typically provides information communication using transmission media through one or more networks to other devices that use or process the information. For example, network link 1578 may provide a connection through local network 1580 to a host computer 1582 or to equipment 1584 operated by an Internet Service Provider (ISP). ISP equipment 1584 in turn provides data communication services through the public, world-wide packet-switching communication network of networks now commonly referred to as the Internet 1590.

A computer called a server host 1592 connected to the Internet hosts a process that provides a service in response to information received over the Internet. For example, server host 1592 hosts a process that provides information representing video data for presentation at display 1514. It is contemplated that the components of system can be deployed in various configurations within other computer systems, e.g., host 1582 and server 1592.

FIG. 16 illustrates a chip set 1600 upon which an embodiment of the invention may be implemented. Chip set 1600 is programmed to detect and code a grade-separated road intersection based on image data as described herein and includes, for instance, the processor and memory components described with respect to FIG. 15 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1600 includes a communication mechanism such as a bus 1601 for passing information among the components of the chip set 1600. A processor 1603 has connectivity to the bus 1601 to execute instructions and process information stored in, for example, a memory 1605. The processor 1603 may include one or more processing cores with each core configured to perform independently. A multi-core processor enables multiprocessing within a single physical package. Examples of a multi-core processor include two, four, eight, or greater numbers of processing cores. Alternatively or in addition, the processor 1603 may include one or more microprocessors configured in tandem via the bus 1601 to enable independent execution of instructions, pipelining, and multithreading. The processor 1603 may also be accompanied with one or more specialized components to perform certain processing functions and tasks such as one or more digital signal processors (DSP) 1607, or one or more application-specific integrated circuits (ASIC) 1609. A DSP 1607 typically is configured to process real-world signals (e.g., sound) in real time independently of the processor 1603. Similarly, an ASIC 1609 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1603 and accompanying components have connectivity to the memory 1605 via the bus 1601. The memory 1605 includes both dynamic memory (e.g., RAM, magnetic disk, writable optical disk, etc.) and static memory (e.g., ROM, CD-ROM, etc.) for storing executable instructions that when executed perform the inventive steps described herein to detect and code a grade-separated road intersection based on image data. The memory 1605 also stores the data associated with or generated by the execution of the inventive steps.

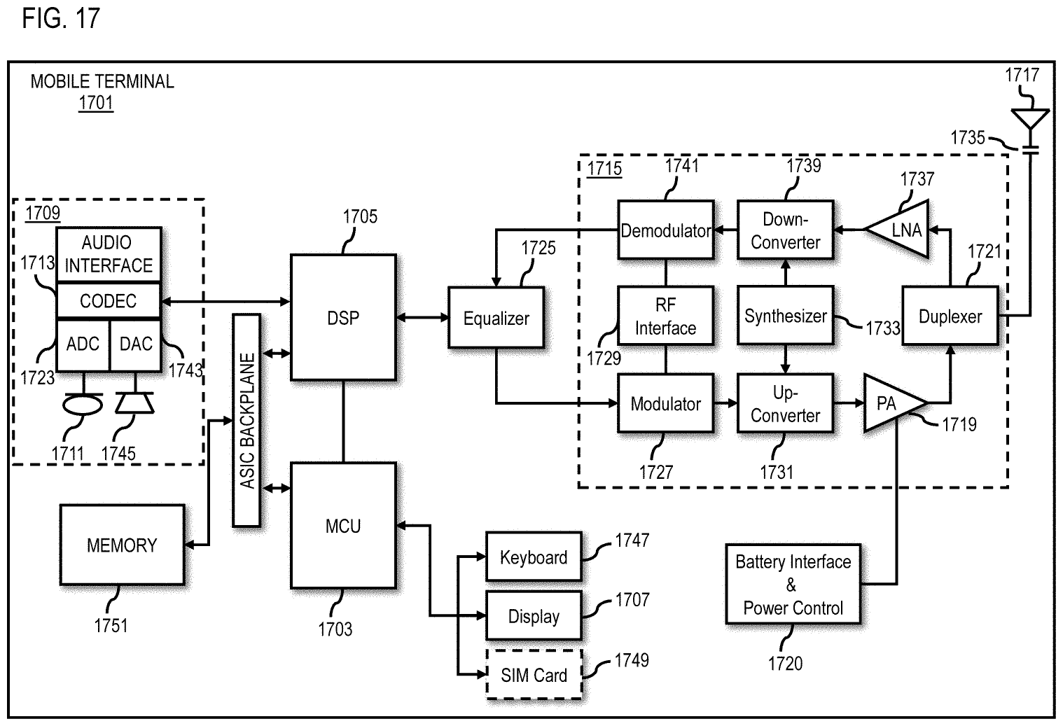

FIG. 17 is a diagram of exemplary components of a mobile terminal 1701 (e.g., handset or vehicle or part thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1703, a Digital Signal Processor (DSP) 1705, and a receiver/transmitter unit including a microphone gain control unit and a speaker gain control unit. A main display unit 1707 provides a display to the user in support of various applications and mobile station functions that offer automatic contact matching. An audio function circuitry 1709 includes a microphone 1711 and microphone amplifier that amplifies the speech signal output from the microphone 1711. The amplified speech signal output from the microphone 1711 is fed to a coder/decoder (CODEC) 1713.

A radio section 1715 amplifies power and converts frequency in order to communicate with a base station, which is included in a mobile communication system, via antenna 1717. The power amplifier (PA) 1719 and the transmitter/modulation circuitry are operationally responsive to the MCU 1703, with an output from the PA 1719 coupled to the duplexer 1721 or circulator or antenna switch, as known in the art. The PA 1719 also couples to a battery interface and power control unit 1720.

In use, a user of mobile station 1701 speaks into the microphone 1711 and his or her voice along with any detected background noise is converted into an analog voltage. The analog voltage is then converted into a digital signal through the Analog to Digital Converter (ADC) 1723. The control unit 1703 routes the digital signal into the DSP 1705 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1725 for compensation of any frequency-dependent impairments that occur during transmission though the air such as phase and amplitude distortion. After equalizing the bit stream, the modulator 1727 combines the signal with a RF signal generated in the RF interface 1729. The modulator 1727 generates a sine wave by way of frequency or phase modulation. In order to prepare the signal for transmission, an up-converter 1731 combines the sine wave output from the modulator 1727 with another sine wave generated by a synthesizer 1733 to achieve the desired frequency of transmission. The signal is then sent through a PA 1719 to increase the signal to an appropriate power level. In practical systems, the PA 1719 acts as a variable gain amplifier whose gain is controlled by the DSP 1705 from information received from a network base station. The signal is then filtered within the duplexer 1721 and optionally sent to an antenna coupler 1735 to match impedances to provide maximum power transfer. Finally, the signal is transmitted via antenna 1717 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1701 are received via antenna 1717 and immediately amplified by a low noise amplifier (LNA) 1737. A down-converter 1739 lowers the carrier frequency while the demodulator 1741 strips away the RF leaving only a digital bit stream. The signal then goes through the equalizer 1725 and is processed by the DSP 1705. A Digital to Analog Converter (DAC) 1743 converts the signal and the resulting output is transmitted to the user through the speaker 1745, all under control of a Main Control Unit (MCU) 1703—which can be implemented as a Central Processing Unit (CPU) (not shown).

The MCU 1703 receives various signals including input signals from the keyboard 1747. The keyboard 1747 and/or the MCU 1703 in combination with other user input components (e.g., the microphone 1711) comprise a user interface circuitry for managing user input. The MCU 1703 runs a user interface software to facilitate user control of at least some functions of the mobile station 1701 to detect and code a grade-separated road intersection based on image data. The MCU 1703 also delivers a display command and a switch command to the display 1707 and to the speech output switching controller, respectively. Further, the MCU 1703 exchanges information with the DSP 1705 and can access an optionally incorporated SIM card 1749 and a memory 1751. In addition, the MCU 1703 executes various control functions required of the station. The DSP 1705 may, depending upon the implementation, perform any of a variety of conventional digital processing functions on the voice signals. Additionally, DSP 1705 determines the background noise level of the local environment from the signals detected by microphone 1711 and sets the gain of microphone 1711 to a level selected to compensate for the natural tendency of the user of the mobile station 1701.

The CODEC 1713 includes the ADC 1723 and DAC 1743. The memory 1751 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1751 may be, but not limited to, a single memory, CD, DVD, ROM, RAM, EEPROM, optical storage, or any other non-volatile or non-transitory storage medium capable of storing digital data.

An optionally incorporated SIM card 1749 carries, for instance, important information, such as the cellular phone number, the carrier supplying service, subscription details, and security information. The SIM card 1749 serves primarily to identify the mobile station 1701 on a radio network. The card 1749 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
retrieving an image depicting a road intersection from a top-down perspective, the road intersection comprising two or more road links;
processing the image to determine continuity data of the two or more road links, the continuity data representing a visual continuity of respective depictions of the two or more road links in the image;
determining a stacking order of the two or more road links based on the continuity data; and
providing the stacking order as an output.

2. The method of claim 1, wherein the processing of the image comprises converting the image to a monochrome image, and wherein the continuity data is determined from the monochrome image.

3. The method of claim 1, further comprising:
assigning a top stack level of the stacking order to a road link of the two or more road links based on determining that the continuity data indicates that the respective depictions of the road link in the image is visually continuous.

4. The method of claim 1, further comprising:
assigning a middle stack level of the stacking order to at least one road link of the two or more road links based on determining that (1) the continuity data indicates that the respective depictions of the at least one road link is non-continuous, and (2) respective shadows of the at least one road link are present in the image.

5. The method of claim 1, further comprising:
assigning a lowest stack level of the stacking order to a road link of the two or more road links based on determining that (1) the continuity data indicates that the respective depictions of the road link is non-continuous, and (2) a shadow of the road link is not present in the image.

6. The method of claim 1, further comprising:
assigning a negative stack level of the stacking order to a road link of the two or more road links based on determining that the road link is not visible in the image.

7. The method of claim 1, further comprising:
assigning a negative stack level of the stacking order to a road link of the two or more road links based on determining that the road link is associated with a water feature.

8. The method of claim 1, further comprising:
retrieving probe data collected from one or more vehicles traveling the road intersection;
processing the probe data to determine elevation data for the two or more road links; and
determining or validating the stacking order based on the elevation data.

9. The method of claim 1, further comprising:
retrieving street-level imagery depicting the road intersection;
processing the street-level imagery to perform an image segmentation of the street-level imagery into a road image segment, a horizon image segment, a sky image segment, or a combination; and
determining or validating the stacking order based on the image segmentation.

10. The method of claim 9, wherein the street-level imagery includes a plurality of images captured over a drive sequence, and wherein the continuity data for determining the stacking order is determined based on a change of the image segmentation over the drive sequence.

11. The method of claim 1, wherein the image is a satellite image or an aerial image.

12. The method of claim 1, further comprising:
storing the stacking order as map data of a geographic database.

13. An apparatus comprising:
at least one processor; and
at least one memory including computer program code for one or more programs,
the at least one memory and the computer program code configured to, with the at least one processor, cause the apparatus to perform at least the following,
retrieve an image depicting a road intersection from a top-down perspective, the road intersection comprising two or more road links;
process the image to determine continuity data of the two or more road links, the continuity data representing a visual continuity of respective depictions of the two or more road links in the image;
determine a stacking order of the two or more road links based on the continuity data; and
provide the stacking order as an output.

14. The apparatus of claim 13, wherein the processing of the image comprises converting the image to a monochrome image, and wherein the continuity data is determined from the monochrome image.

15. The apparatus of claim 13, wherein the apparatus is further caused to:
assign a top stack level of the stacking order to a road link of the two or more road links based on determining that the continuity data indicates that the respective depictions of the road link in the image is visually continuous.

16. The apparatus of claim 13, wherein the apparatus is further caused to:
assign a middle stack level of the stacking order to at least one road link of the two or more road links based on determining that (1) the continuity data indicates that the respective depictions of the at least one road link is non-continuous, and (2) respective shadows of the at least one road link are present in the image.

17. The apparatus of claim 13, wherein the apparatus is further caused to:
assign a lowest stack level of the stacking order to a road link of the two or more road links based on determining that (1) the continuity data indicates that the respective depictions of the road link is non-continuous, and (2) a shadow of the road link is not present in the image.

18. A computer readable storage medium including one or more sequences of one or more instructions which, when executed by one or more processors, cause an apparatus to at least perform:
retrieving an image depicting a road intersection from a top-down perspective, the road intersection comprising two or more road links;
processing the image to determine continuity data of the two or more road links, the continuity data representing a visual continuity of respective depictions of the two or more road links in the image;
determining a stacking order of the two or more road links based on the continuity data; and
providing the stacking order as an output.

19. The computer readable storage medium of claim 18, wherein the processing of the image comprises converting the image to a monochrome image, and wherein the continuity data is determined from the monochrome image.

20. The computer readable storage medium of claim 18, wherein the apparatus is further caused to perform:
assigning a top stack level of the stacking order to a road link of the two or more road links based on determining that the continuity data indicates that the respective depictions of the road link in the image is visually continuous.
